(19) United States
(12) Patent Application Publication
(10) Pub. No.: US 2024/0337498 A1
(43) Pub. Date: Oct. 10, 2024

(54) ROUTE SEARCH DEVICE, ROUTE SEARCH METHOD, AND RECORDING MEDIUM

(71) Applicant: NEC Corporation, Minato-ku, Tokyo (JP)

(72) Inventors: Chisato SUGAWARA, Tokyo (JP); Yosuke KIMURA, Tokyo (JP); Nana JUMONJI, Tokyo (JP); Takakazu ISHII, Tokyo (JP); Daisuke HASHIZUME, Tokyo (JP); Hiromichi HIRATA, Tokyo (JP); Shouhei OHNO, Tokyo (JP)

(73) Assignee: NEC Corporation, Minato-ku, Tokyo (JP)

(21) Appl. No.: 18/681,920

(22) PCT Filed: Aug. 26, 2021
(86) PCT No.: PCT/JP2021/031306

§ 371 Date: Feb. 7, 2024

(51) Int. Cl. G01C 21/34; G01C 21/36

(52) U.S. Cl. CPC G01C 21/3461; G01C 21/3492; G01C 21/3617; G01C 21/3691

(57) ABSTRACT

In order to search for a suitable route, including regions where vehicles cannot pass, a route search device according to the present invention includes: a traffic information generating means for generating road traffic information by using sensor information relating to the road acquired by a sensor information acquisition device; a disaster range identifying means for identifying a disaster range by using a terrain change obtained on the basis of measurement results by a terrain measurement device; and a route searching means for searching for a route to a prescribed site by using the disaster range and the traffic information.

### TECHNICAL FIELD

The present invention relates to a route, and in particular to a route during a disaster.

### BACKGROUND ART

At the time of occurrence of a disaster, a disaster situation is investigated. For example, PTL 1 describes a technique related to an investigation of a disaster situation. The disaster countermeasure assistance method described in PTL 1 grasps a disaster situation using a synthetic aperture radar mounted on an artificial satellite. A route is searched for using an image acquired from a vehicle. For example, PTL 2 describes a technique related to a search for a route. The route search device described in PTL 2 determines a state of a road using an image acquired from a vehicle, and searches for a route using a result of the determination.

### CITATION LIST

### Patent Literature

PTL 1: WO 2008/016153 A1
PTL 2: JP 2020-094959 A

### SUMMARY OF INVENTION

### Technical Problem

Since the technique described in PTL 1 is a technique using a synthetic aperture radar, a detailed state of a road or the like cannot be determined in some cases. Since the technique described in PTL 2 is a technique using an image acquired from a vehicle, a route cannot be searched for in an area where a vehicle cannot pass. An object of the present invention is to provide a route search device that searches for an appropriate route including an area where a vehicle cannot pass.

### Solution to Problem

A route search device according to an aspect of the present invention includes a passage information generation means configured to generate passage information about a road, using sensor information related to the road, the sensor information being acquired by a sensor information acquisition device, a disaster area identification means configured to identify a disaster area using a change in a ground surface obtained based on a measurement result created by the ground surface measurement device, and a route search means configured to search for a route to a predetermined point using the disaster area and the passage information.

A route search system according to an aspect of the present invention includes the route search device described above, and a sensor information acquisition device that outputs sensor information to a route search device.

A route search method according to an aspect of the present invention includes generating passage information about a road by using sensor information related to the road, the sensor information being acquired by a sensor information acquisition device, identifying a disaster area using a change in a ground surface obtained based on a measurement result created by the ground surface measurement device, and searching for a route to a predetermined point using the disaster area and the passage information.

A route search method according to an aspect of the present invention includes a route search device executing the route search method, and a sensor information acquisition device outputting the sensor information to the route search device.

A recording medium according to an aspect of the present invention records a program for causing a computer to execute the steps of generating passage information about a road by using sensor information related to the road, the sensor information being acquired by a sensor information acquisition device, identifying a disaster area using a change in a ground surface obtained based on a measurement result created by the ground surface measurement device, and searching for a route to a predetermined point using the disaster area and the passage information.

### Advantageous Effects of Invention

According to the present invention, it is possible to obtain an effect of searching for an appropriate route including an area where vehicles cannot pass.

### BRIEF DESCRIPTION OF DRAWINGS

FIG. 1 is a block diagram illustrating an example of a configuration of a route search system according to a first example embodiment.

FIG. 2 is a conceptual diagram illustrating an example of a configuration of a route search system according to the first example embodiment.

FIG. 3 is a diagram illustrating a departure place and a destination used for description.

FIG. 4 is a diagram illustrating an example of a route at the time of disaster.

FIG. 5 is a flowchart illustrating an example of an operation of the route search device according to the first example embodiment.

FIG. 6 is a block diagram illustrating an example of a hardware configuration of the route search device.

FIG. 7 is a block diagram illustrating an example of a configuration of a route search system according to a second example embodiment.

FIG. 8 is a diagram for explaining a route searched by a route search unit based on a prediction of a disaster area.

FIG. 9 is a flowchart illustrating an example of an operation of the route search device according to the second example embodiment.

FIG. 10 is a block diagram illustrating an example of a configuration of a route search device according to a third example embodiment.

FIG. 11 is a block diagram illustrating an example of a configuration of a route search system according to a fourth example embodiment.

### EXAMPLE EMBODIMENT

Next, an example embodiment of the present invention will be described with reference to the drawings. However, the example embodiment of the present invention is not limited to the description of each drawing. Each example embodiment can be appropriately combined.

### <Terms>

The “sensor information acquisition device” is a device that includes a predetermined sensor and acquires sensor information related to a structure and its periphery. For example, the structure may include at least one of a road, a bridge, a slope frame, an embankment, a pier, a revetment, and a runway. The sensor information will be described later. The sensor information acquisition device may be a device that is mounted on or towed by a mobile body and moves, or may be a fixed device. For example, the mobile body may be a vehicle, an unmanned aerial vehicle (drone), or a person. The moving device may be, for example, a dashboard camera (dashcam). The fixed device may be, for example, a fixed camera. The fixed camera used as the sensor information acquisition device is not limited to a camera having a fixed imaging direction, and may be a camera capable of changing at least one of an imaging direction and an imaging position in a certain range.

The “sensor information” is information acquired using a predetermined sensor in order to determine a situation of a structure and a situation around the structure. For example, the sensor may include a camera, a speed meter, an accelerometer, an angle meter, or a distance meter. The acquired information may include, for example, an image, a velocity, acceleration, an angle, or a distance. For example, the sensor information is an image captured or acceleration measured by a dashcam mounted on a vehicle traveling on a structure such as a road or a bridge. Alternatively, in a case where the sensor is light detection and ranging (LIDAR), the sensor information is distance information. The sensor information may include a plurality of pieces of information. The plurality of pieces of information may be, for example, an image and acceleration, or a plurality of images such as a moving image. However, the sensor information is not limited to the image, the velocity, the acceleration, and the distance, and may be any information as long as the information can be used for a route search. In other words, the sensor is not limited to a camera, a speed meter, an accelerometer, an angle meter, or a distance meter.

Further, the sensor information may include information different from the information acquired by the sensor. For example, the sensor information may include information related to acquisition of the sensor information. The information related to the acquisition of the sensor information may be, for example, an acquisition time or an acquisition position. Hereinafter, the information related to the acquisition of the sensor information is referred to as “acquisition-related information”. Alternatively, the sensor information may include information related to the sensor information acquisition device or information related to the sensor. The information related to the sensor information acquisition device is, for example, a device name, an attachment position, or an orientation of the sensor information acquisition device. Alternatively, the information related to the sensor is, for example, a specification of the sensor. Hereinafter, the information related to the sensor information acquisition device and the information related to the sensor are collectively referred to as “acquisition device information”.

Furthermore, the sensor information may include information related to the mobile body on which the sensor information acquisition device is mounted. The mobile body is, for example, a vehicle. The information related to the mobile body is, for example, a model number or a vehicle type of the vehicle. Hereinafter, the information related to the mobile body is referred to as “mobile body information”. Furthermore, the sensor information may include information related to the operation of the mobile body on which the sensor information acquisition device is mounted. In the case of the vehicle, the information related to the operation of the mobile body is, for example, information related to an operation such as an accelerator pedal, a brake pedal, a shift lever, a steering wheel, a wiper, a blinker, and opening and closing of a door. Hereinafter, information related to the operation of the mobile body is referred to as “operation information”. Alternatively, the sensor information may include information related to the periphery of the sensor information acquisition device in the acquisition of the sensor information. For example, the information related to the periphery may include weather, temperature, humidity, illuminance, congestion, or voice. Hereinafter, information related to the periphery is referred to as “peripheral information”. Alternatively, the sensor information may include information added by the operator of the acquisition work. The information added by the operator is, for example, a comment of the operator. Hereinafter, the information added by the operator is referred to as “additional information”.

In the following description, the information included in the sensor information excluding the information acquired by the sensor is collectively referred to as “related information”. The information included in the sensor information is information including at least one of acquisition-related information, acquisition device information, mobile body information, operation information, peripheral information, and additional information. In this manner, the sensor information may include related information in addition to the information acquired by the sensor. However, the related information may be treated as information different from the information acquired by the sensor. For example, one file may store the information acquired by the sensor and the related information as separate information. However, in the following description, the sensor information will be described as including related information.

A specific example of association between the sensor information acquisition device, the sensor, and the sensor information will be described. For example, in a case where the sensor information acquisition device is a dashcam, the sensor is a camera. The sensor information is, for example, an image. In a case where the sensor information acquisition device is an acceleration meter, the sensor is an acceleration sensor. The sensor information is acceleration. The sensor information acquisition device may include a plurality of sensors. The plurality of sensors in this case may be a plurality of sensors of the same type or a plurality of types of sensors. The plurality of types of sensors is, for example, a camera, an accelerometer, and an angle meter. In the following description, a dashcam, a camera, and an image are used as examples of the sensor information acquisition device, the sensor, and the sensor information, respectively. A vehicle is used as an example of the mobile body.

The “synthetic aperture radar” is a radar in which while moving, a flying object transmits and receives a radio wave and obtains an image equivalent to that of an antenna having a large opening. Hereinafter, the synthetic aperture radar is referred to as an “SAR”. The resolution in radar observation is improved as the antenna is increased. However, the size of an antenna that can be mounted on an artificial satellite or the like is limited. Therefore, the SAR transmits and receives radio waves while flying using an antenna having a small actual opening length, thereby improving the resolution in the traveling direction. That is, the SAR artificially “combines” the “openings” to form a virtually large antenna. The flying object is not limited as long as it is a flying object equipped with the SAR, and may be any flying object. For example, the flying object is an artificial satellite, an aircraft, or an unmanned aerial vehicle (drone).

The SAR outputs an image as a measurement result. Hereinafter, an image as a measurement result is referred to as an “SAR image”. Each example embodiment can analyze a “change in the ground surface” using SAR images. Hereinafter, the change in the ground surface may be simply referred to as a “ground surface change”. For example, each example embodiment can analyze a change in height of the ground surface between two times as a change in the ground surface using two SAR images at different times at the same location. Alternatively, each example embodiment can analyze a change in intensity of the ground surface as a change in the ground surface.

The method of analyzing the change in height and the change in intensity according to each example embodiment is not particularly limited. In each example embodiment, any method may be used as the analysis method. For example, each example embodiment may use a technique such as change extraction, time series interference analysis, or coherent change extraction. Alternatively, each example embodiment may execute machine training using a past SAR image or the like as teacher data, and apply the SAR image to an analysis model generated as a result of execution of the machine training to analyze a change in the ground surface. The analysis of the change in the ground surface is not limited to the analysis of a change in height of the ground surface and a change in intensity of the ground surface, and may include another analysis. For example, the another analysis may be at least one of an analysis of a factor of a change in the ground surface and an analysis of a magnitude of a risk based on the change in the ground surface. As described above, the SAR is a device that measures the ground surface in order to acquire the measurement result for analyzing a change in the ground surface.

However, in each example embodiment, a device that acquires a measurement result for analyzing a change in the ground surface, that is, a device that measures the ground surface, is not limited to the SAR. Examples of the device that measures the ground surface include an optical sensor or a laser measuring device mounted on any of an artificial satellite, an aircraft, and an unmanned aerial vehicle (drone). Each example embodiment may analyze a change in the ground surface using measurement results by a device or a system that measures the ground surface as described above. The measurement result is, for example, an optical image. In the following description, the devices or the systems that measure the ground surface are collectively referred to as a “ground surface measurement device”.

The ground surface measurement device includes a device that analyzes a “change in a ground surface” using a measurement result to output the “change in the ground surface” that is a result of the analysis. That is, the ground surface measurement device may output a measurement result or may output a change in the ground surface as an analysis result. Therefore, in the following description, in order to avoid complication of the description, the above cases will be summarized unless otherwise distinguished and described, and the device of each example embodiment will be described as acquiring a change in the ground surface obtained based on the measurement result created by the ground surface measurement device. In the following description, the SAR and the SAR image are used as examples of the ground surface measurement device and the measurement result.

The SAR includes a device capable of acquiring a measurement result using a plurality of frequencies (multispectra). Hereinafter, a device capable of acquiring a measurement result using multispectra is referred to as a “multispectra measurement device”. When the measurement result using the multispectra is used, not only the change in the ground surface but also the type of the ground surface can be analyzed. Therefore, each example embodiment may analyze the type of the ground surface using the measurement result by the SAR using multispectra, and use the analyzed type of the ground surface. The type of the ground surface is determined in accordance with the frequency to be used. For example, the type of the ground surface includes at least any one of a water surface, mud, garbage, dry soil, a grassland, a forest, and snow cover. As described above, the type of the ground surface is one of the analysis results of the measurement results of the ground surface. Therefore, in the following description, a change in the ground surface including the type of the ground surface is referred to unless a particularly distinguished description is necessary. That is, the change in the ground surface in the following description may include the type of ground surface.

The measurement result created by the ground surface measurement device such as the SAR includes a wide range to some extent. Therefore, the analysis using the measurement result created by the ground surface measurement device such as the SAR can acquire a certain wide range of a change in the ground surface. The SAR also measures the ground surface from a certain altitude. Therefore, the ground surface measurement device such as the SAR can measure the ground surface even when a disaster or the like occurs. However, the accuracy of the analysis result using the measurement result acquired by the SAR is often of an order of meters. It is often desirable that the accuracy of determining the situation of the road or the like is of an order of several centimeters to a dozen centimeters. On the other hand, the accuracy of the determination using the sensor information acquired from the dashcam is of an order of several centimeters to several tens of centimeters. However, the dashcam cannot acquire sensor information about an area through which the vehicle cannot pass.

Therefore, it is desired to achieve the degree of accuracy similar to that of the search using the sensor information at least in part, and to search for a route determined including an area where the sensor information cannot be acquired such as a vehicle cannot pass. As described below, each example embodiment of the present invention searches for an appropriate route using a change in the ground surface obtained based on the measurement result created by the ground surface measurement device and the sensor information acquired by the sensor information acquisition device.

### First Example Embodiment

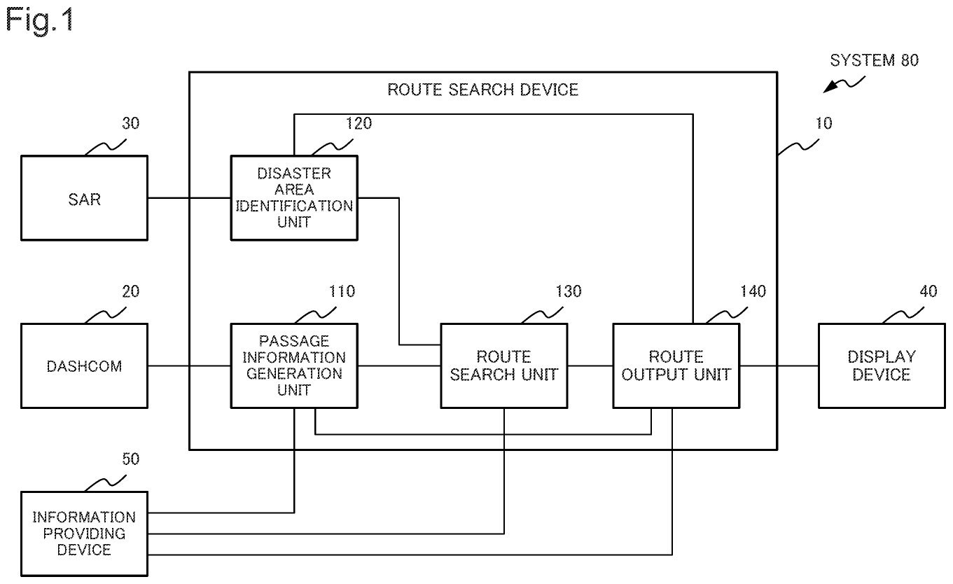

First, a configuration of a route search system 80 according to a first example embodiment will be described with reference to the drawings. FIG. 1 is a block diagram illustrating an example of a configuration of the route search system 80 according to the first example embodiment. The route search system 80 includes a route search device 10, a dashcam 20, an SAR 30, a display device 40, and an information providing device 50. The number of components in FIG. 1 is an example, and is not limited to the number illustrated in FIG. 1. For example, the route search system 80 may include a plurality of dashcams 20.

The dashcam 20 outputs the sensor information to the route search device 10. The dashcam 20 is mounted on a vehicle, for example, and acquires sensor information such as a road on which the vehicle travels. The sensor information is, for example, an image of a road. Then, the dashcam 20 outputs the acquired sensor information to the route search device 10. However, the mobile means of the dashcam 20 is not limited to the vehicle. For example, the dashcam 20 may be mounted on a mobile body other than the vehicle. The mobile body other than the vehicle is, for example, an unmanned aerial vehicle (drone). Alternatively, a person or the like may carry the dashcam 20. In the present example embodiment, a device that is fixed at any place and can acquire and output sensor information, such as a fixed camera may be included as the dashcam 20.

The route search system 80 is not limited to include one dashcam, but may include a plurality of dashcams 20. In this case, at least part of the mobile means of each dashcam 20 may be different. For example, the route search system 80 may include a dashcam 20 mounted on the vehicle and a dashcam 20 fixed at a predetermined position.

The SAR 30 outputs a measurement result or a change in the ground surface to the route search device 10. For example, the SAR 30 outputs an SAR image as a measurement result to the route search device 10. In this case, the route search device 10 may analyze the “change in the ground surface” using the SAR image acquired from the SAR 30. The SAR 30 may output an SAR image in a preset range, or may output an SAR image in a range requested by the route search device 10. The preset range is, for example, an imaging range or a measurement range.

Alternatively, the SAR 30 may output, to the route search device 10, a “change in the ground surface” that is a result of analyzing the SAR image. Also in this case, the SAR 30 may output a change in the ground surface in a preset range, or may output a change in the ground surface in a range requested by the route search device 10. The preset range is, for example, an analysis range. The SAR 30 may measure the ground surface using multispectra. In this case, the SAR 30 may output a multispectral measurement result or may output a type of the ground surface analyzed using the multispectral measurement result.

The display device 40 displays information output by the route search device 10. The information output by the route search device 10 is, for example, a route. The display device 40 may be any device as long as the device displays information output by the route search device 10. The installation position of the display device 40 may be any place as long as it can be installed. Alternatively, the display device 40 may be a portable device such as a cellular phone, a smartphone, or a tablet, instead of a device installed at a predetermined place. For example, the display device 40 may be a display included in a disaster assistance system of a local government. Alternatively, the display device 40 may be a device mounted on a vehicle on which the dashcam 20 is mounted. The device mounted on the vehicle is, for example, a car navigation device. Alternatively, the display device 40 may be a device individually carried by a user or the like. The device carried by the user or the like is, for example, a smartphone. Furthermore, the display device 40 may be a device included in any device or a device including another device. For example, the display device 40 may be included in the route search device 10. Alternatively, the display device 40 may be a device including the route search device 10.

The information providing device 50 provides information requested from the route search device 10. The information providing device 50 may be any device as long as the device provides information requested from the route search device 10. A user or the like of the route search device 10 may determine information to be acquired from the information providing device 50 and the information providing device 50 in consideration of information necessary for a route search in the route search device 10. For example, the information providing device 50 may provide map information such as a road to the route search device 10. Alternatively, the information providing device 50 may provide information related to a disaster to the route search device 10. Hereinafter, information related to a disaster is referred to as “disaster information”.

The disaster information is not limited. The disaster information may be any information as long as it is related to a disaster of interest. For example, the disaster information may be information related to an occurring disaster such as a disaster area, a secondary disaster, and past disaster information. Alternatively, the disaster information may be weather-related information such as a rainfall range, a rainfall amount, rain cloud information, a wind direction, a wind volume, a snowfall range, and a snow cover amount. The rain cloud information is, for example, a position, a range, and a movement direction of the rain cloud. Alternatively, the disaster information may be information related to an earthquake, such as a seismic source, a seismic intensity, and a situation of an aftershock. Alternatively, the disaster information may be information related to a social infrastructure such as a power outage, a water outage, or a supply stop of city gas. Alternatively, the disaster information may be a map related to a disaster. For example, the map related to a disaster may be a hazard map, an evacuation place map, or an available store map. The disaster information may be information about a structure having a high-risk. For example, the high-risk structures may include a tunnel and a bridge.

The route search device 10 searches for a route from the departure place to the destination that were designated. Therefore, the route search device 10 acquires the sensor information from the dashcam 20. For example, the route search device 10 acquires an image of a road from the dashcam 20. The route search device 10 may acquire the sensor information from the dashcam 20 or may acquire the sensor information from a device storing the sensor information acquired by the dashcam 20. However, in the following description, as an example, the route search device 10 will be described as acquiring the sensor information from the dashcam 20.

Then, the route search device 10 generates passage information. The “passage information” is information indicating whether a mobile body can pass through a road. The mobile body is, for example, a vehicle or a person. In a case where there is a plurality of roads, the passage information is information indicating whether a mobile body can pass through at least some of the roads. In the present example embodiment, the “road” is not limited to a road on the ground as long as at least one of a vehicle and a person can pass through the road. For example, the road may be a road on a bridge or a road on an elevated structure. Further, when the passage information is generated, states of structures related to roads such as a pavement, a bridge pier, an elevated structure, and a tunnel may be considered.

The passage information may include information related to whether the mobile body can pass through a structure different from the road. For example, the passage information may include information related to whether a person can pass through a passable stair, a pedestrian bridge, a sidewalk at an upper portion of a bank or a top end of an embankment, a road in a park, a walk road, a farm road, or a pier. The passage information may be generated using information related to a plurality of structures. The structures are, for example, a road and a bridge. However, in the following description, as an example, the passage information will be described as information about whether a mobile body can pass through a road.

The passage information is not particularly limited as long as it is information related to whether the mobile body can pass through the road, and may be information including any information. For example, the passage information may include at least one piece of information indicating an area of a road through which the mobile body can pass and information indicating an area of a road through which the mobile body cannot pass. Hereinafter, information indicating an area of a road through which a mobile body can pass is referred to as a “passable area”, and information indicating an area of a road through which a mobile body cannot pass is referred to as an “impassable area”.

The passable area and the impassable area are not limited to an area of a road that is completely passable and an area of a road that is completely impassable, respectively. The passable area and the impassable area may be determined based on the possibility that the mobile body can pass through the road. Hereinafter, the possibility that the mobile body can pass through the road is referred to as a “possibility of passage”. The possibility of passage is represented by, for example, a probability. For example, the route search device 10 may determine the possibility of passage of a road using the sensor information, and may set an area of a road having a predetermined possibility of passage or more as a passable area and set an area of other roads as an impassable area. The predetermined possibility of passage is, for example, 60%.

The passage information may include a plurality of areas as at least one of the passable area and the impassable area. That is, the passage information may include one or more areas as at least one of the passable area and the impassable area. Further, at least one of the passable area and the impassable area may include the possibility of passage of a road included in the area. In a case where at least one of the passable area and the impassable area includes a plurality of roads, the area may include a plurality of possibilities of passage related to the plurality of roads. For example, in a case where at least one of the passable area and the impassable area includes a plurality of roads, the area may include the possibility of passage for each road included in the area.

The route search device 10 cannot determine a passable area or an impassable area in an area where sensor information cannot be acquired. Hereinafter, an area where sensor information cannot be acquired is referred to as a “non-acquisition area”. However, in searching for a route, it is desirable that the route search device 10 search for a route while avoiding an area where it is unknown whether it is possible to pass through. Therefore, the route search device 10 may include the non-acquisition area in the impassable area. In the following description, it is assumed that the impassable area includes a non-acquisition area unless a particularly distinguished description is required. However, the handling of the non-acquisition area is not limited thereto. The non-acquisition area may be included in the passable area, or may be treated separately from the passable area and the impassable area.

Further, the route search device 10 acquires an SAR image from the SAR 30, and analyzes a change in the ground surface using the acquired SAR image. Alternatively, the route search device 10 acquires, from the SAR 30, a change in the ground surface that is a result of analyzing the SAR image acquired by the SAR 30. That is, although the subject of the analysis is different, the route search device 10 acquires a change in the ground surface that is a result of the analysis using the measurement result by the SAR 30. The measurement result by the SAR 30 is, for example, an SAR image. Then, the route search device 10 identifies a disaster area using the acquired change in the ground surface. The route search device 10 may identify not one disaster area but a plurality of disaster areas. Hereinafter, the range of disaster is also referred to as a “disaster area”.

The route search device 10 may acquire the SAR image or the change in the ground surface from the SAR 30, or may acquire the SAR image or the change in the ground surface from a device that stores the SAR image or the change in the ground surface. However, in the following description, as an example, the route search device 10 will be described as acquiring an SAR image or a change in the ground surface from the SAR 30.

Then, the route search device 10 searches for a route to a predetermined point (destination) on the road used by the mobile body based on the passage information and the disaster area. The mobile body is, for example, a vehicle or a person. The route search device 10 may search for a route related to each of a plurality of mobile bodies. The route is, for example, a route for a vehicle and a route for a person. Alternatively, the route search device 10 may search for a route related to all of the plurality of mobile bodies. The route is, for example, a route through which both a vehicle and a person can pass. A departure place and a destination of the route are not particularly limited. For example, in the case of a route used for distribution of supplies, the departure place is a location of a storage of supplies. And the destination is a location where the supplies are distributed. Alternatively, in the case of the evacuation route, the departure place is a current position of each evacuee. The destination is, for example, an evacuation place.

Then, the route search device 10 outputs the searched route to a predetermined device. The predetermined device is, for example, the display device 40. The route search device 10 may start an operation in response to any condition. For example, in a case where a disaster warning is received from a disaster alarm device (not illustrated), the route search device 10 may search for a route. Alternatively, the route search device 10 may search for a route in response to a request from a user or the like. The route search device 10 may acquire at least one of a road on which a route is to be searched for, a mobile body, a departure place, and a destination from a user or the like. For example, the route search device 10 may acquire an evacuation place as a destination from a user or the like. However, the route search device 10 may acquire in advance at least one of a road on which a route is to be searched for, a mobile body, a departure place, and a destination.

The route search device 10 may repeat the route search not once but every predetermined period or at a predetermined timing. For example, the route search device 10 may repeat the route search by reacquiring the sensor information every 1 hour. Alternatively, the route search device 10 may re-search for a route when re-acquiring at least one of new sensor information and a new change in the ground surface. Alternatively, when there is a request from the user, the route search device 10 may search for a route related to the request by the user. In a case where a route is requested by a plurality of users or the like, the route search device 10 may execute at least some operations in parallel in a plurality of searches.

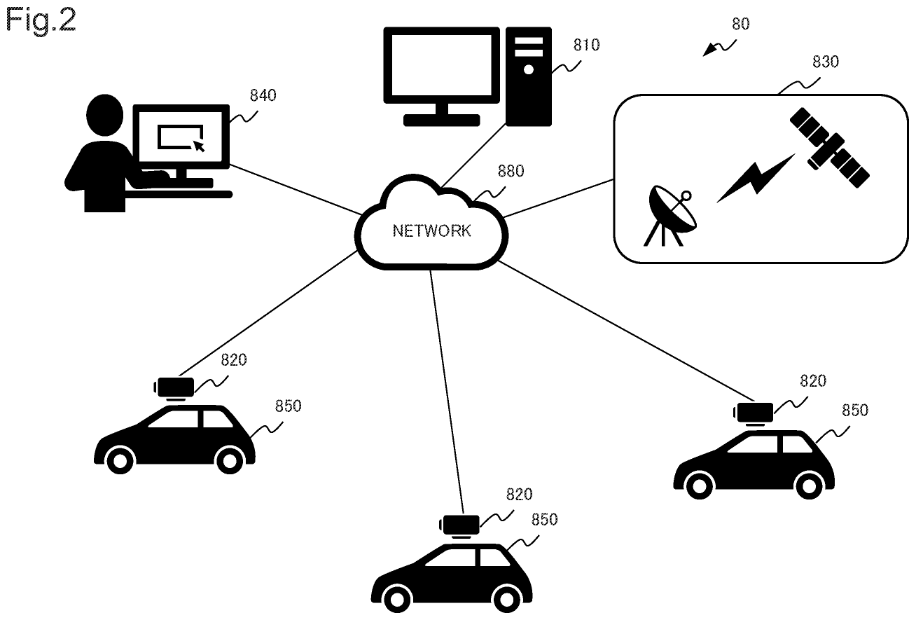

FIG. 2 is a conceptual diagram illustrating an example of a configuration of the route search system 80 according to the first example embodiment. The route search system 80 of FIG. 2 includes a computer 810 as an example of the route search device 10, a dashcam 820 as an example of the dashcam 20, and an SAR system 830 including an artificial satellite and a ground station as an example of the SAR 30. Further, the route search system 80 in FIG. 2 includes a terminal device 840 as an example of the display device 40. Further, the route search system 80 of FIG. 2 includes a vehicle 850 as an example of a mobile body that moves with the dashcam 820 mounted thereon.

Further, the route search system 80 of FIG. 2 includes a network 880 as a communication path connecting each device and system. The network 880 is a communication path that connects each device and the system to each other. The network 880 is not particularly limited as long as each device and the system can be connected. For example, the network 880 may be the Internet, a public telephone line, or a combination thereof. In FIG. 2, the information providing device 50 is omitted.

The configuration of the route search system 80 included in FIG. 2 is an example. The number of each component is not limited to the example illustrated in FIG. 2. For example, the route search system 80 may include one, two, or four or more dashcams 820. Alternatively, at least some of the dashcams 820 may not be mounted on the vehicle 850. For example, the route search system 80 may include a fixed camera as the dashcam 820. In FIG. 2, the dashcam 820 is displayed outside the vehicle 850 for easy understanding. However, the dashcam 820 may be mounted inside the vehicle 850.

The vehicle 850 travels on a road with the dashcam 820 mounted. The dashcam 820 is mounted on the vehicle 850, acquires sensor information about a road, a bridge, or the like on which the vehicle 850 travels, and outputs the acquired sensor information to the computer 810. The dashcam 820 acquires, for example, an image and acceleration. The computer 810 acquires sensor information from the dashcam 820 and generates passage information using the acquired sensor information.

The computer 810 acquires an SAR image from the SAR system 830, and analyzes a change in the ground surface using the acquired SAR image. However, the computer 810 may acquire a change in the ground surface from the SAR system 830. That is, the computer 810 acquires a change in the ground surface that is a result of an analysis using the SAR image acquired by the SAR system 830. Then, the computer 810 identifies a disaster area using a change in the ground surface. Then, the computer 810 searches for a route to a predetermined point using the passage information and the disaster area. Then, the computer 810 outputs the searched route to the terminal device 840. The terminal device 840 displays the route acquired from the computer 810.

Specific devices to be the computer 810, the dashcam 820, the SAR system 830, the terminal device 840, and the vehicle 850 included in the route search system 80 are not particularly limited. As the computer 810, the dashcam 820, the SAR system 830, the terminal device 840, and the vehicle 850, generally available products and systems may be used. Therefore, a detailed description thereof will be omitted.

Next, a configuration of the route search device 10 will be described with reference to FIG. 1. The route search device 10 includes a passage information generation unit 110, a disaster area identification unit 120, a route search unit 130, and a route output unit 140. The passage information generation unit 110 generates passage information about a road, using sensor information related to the road, the sensor information being acquired by the sensor information acquisition device. The sensor information acquisition device is, for example, the dashcam 20. The disaster area identification unit 120 identifies a disaster area using a change in the ground surface obtained based on the measurement result created by the ground surface measurement device. The ground surface measurement device is, for example, the SAR 30. The route search unit 130 searches for a route to a predetermined point using the disaster area and the passage information. The route output unit 140 outputs the searched route.

The passage information generation unit 110 acquires sensor information from the dashcam 20. The passage information generation unit 110 may acquire a plurality of types of sensor information. The plurality of types of sensor information is, for example, an image and acceleration. The passage information generation unit 110 may acquire the sensor information not from only one dashcam, but from a plurality of dashcams 20. In this case, the passage information generation unit 110 may acquire the same type of sensor information from a plurality of dashcams, or may acquire different types of sensor information. Alternatively, the passage information generation unit 110 may acquire a different number of pieces of sensor information from each of the plurality of dashcams 20. For example, the passage information generation unit 110 may acquire an image from all of the plurality of dashcams 20. Alternatively, the passage information generation unit 110 may acquire images from some of the dashcams 20 and acquire acceleration from the other dashcams 20. Alternatively, the passage information generation unit 110 may acquire images from some of the dashcams 20, acquire acceleration from others of the dashcams 20, and acquire an image and acceleration from the remaining dashcams 20.

Then, the passage information generation unit 110 generates passage information about a road of a predetermined mobile body using the sensor information. The predetermined mobile body is, for example, a vehicle or a person. The passage information is, for example, information including at least one of a passable area and an impassable area. For example, in a case where the dashcam 20 is mounted on the vehicle, the point where the sensor information can be acquired is a point where the vehicle on which the dashcam 20 is mounted can move. Therefore, the passage information generation unit 110 may determine the acquisition position of the sensor information using the information about the position included in the sensor information, and set the area including the determined acquisition position of the sensor information as the passable area. The area including the acquisition position of the sensor information is, for example, an area within a predetermined range from the acquisition position of the sensor information. The sensor information may be information acquired before a disaster occurs. Therefore, the passage information generation unit 110 may refer to the acquisition time included in the sensor information to use the sensor information after the disaster occurs. The area where the passage information is generated by the passage information generation unit 110 is not limited to a road, and passage information about an area other than a road through which a mobile body can pass may be generated. The area other than the road is, for example, an empty area or a site of a factory.

Alternatively, the passage information generation unit 110 may generate passage information about a road based on a state of traffic congestion of the road obtained using the sensor information. For example, the passage information generation unit 110 may determine a state of traffic congestion of a road including a state in which a mobile body such as a vehicle is stopped using the sensor information, and determine an area of a predetermined range including a point where the traffic congestion occurs as an impassable area. For example, the passage information generation unit 110 may determine a state of traffic congestion of a road including a state in which a mobile body such as a vehicle is stopped using an image, acceleration, or operation information, and determine an area of a predetermined range including a point where the traffic congestion occurs as an impassable area. Alternatively, the passage information generation unit 110 may determine an area of a predetermined range including a point where no traffic congestion occurs as a passable area. For example, in a case where the sensor information is acquired from the plurality of dashcams 20, the passage information generation unit 110 determines the state of traffic congestion at the acquisition positions of the plurality of pieces of sensor information, and determines the occurrence range of the traffic congestion using the acquisition position of the sensor information determined as the occurrence of the traffic congestion. Then, the passage information generation unit 110 may determine the determined occurrence range of traffic congestion as an impassable area. Alternatively, the passage information generation unit 110 may determine an area excluding an occurrence range of traffic congestion as a passable area.

The passage information generation unit 110 may determine the possibility of passage on the road using the sensor information, and include the determined possibility of passage in the passage information. For example, when determining a state of traffic congestion, the passage information generation unit 110 may determine the possibility of passage using the determined state of traffic congestion. Alternatively, in a case where the sensor information is an image of a road including heavy rain or many puddles, the passage information generation unit 110 may determine the possibility of passage of a mobile body such as a vehicle using the sensor information. An area having a low possibility of passage is an area where a mobile body is highly likely not to pass. Therefore, the passage information generation unit 110 may set an area in which the possibility of passage is lower than a predetermined value as an impassable area.

Further, the passage information generation unit 110 may generate passage information using information acquired from the information providing device 50. For example, the passage information generation unit 110 may acquire information related to a road from an external device, and determine at least one of a passable area and an impassable area using the acquired information. The information related to the road is, for example, information about road closure or failure/stop of a traffic light. Alternatively, the passage information generation unit 110 may include information acquired from the information providing device 50 in the passage information. For example, the passage information generation unit 110 may acquire map information from the information providing device 50 and associate the generated passage information with the map information. For example, the passage information generation unit 110 may use the passage information as information in which at least one of the passable area and the impassable area is associated with the map information.

Alternatively, the passage information generation unit 110 may use information related to a road posted on a network such as the Internet by a person around the road or a person passing through the road. Hereinafter, information related to a road posted by a person around the road or a person passing through the road is referred to as “posted road information”. The “posted road information” may be history information in a certain time range. For example, the passage information generation unit 110 may generate the passage information using posted road information posted in a social networking service (SNS). For example, a person who lives around a road or a person who is passing through the road may post an image of a congested road or a comment of congestion information about the road on the SNS. Hereinafter, information related to congestion such as images and comments is referred to as “congestion information”. Alternatively, a person passing through a road may post information about a closed road on the SNS. Hereinafter, information related to road closure is referred to as “road closure information”.

Therefore, the passage information generation unit 110 may acquire posted road information of the SNS in a predetermined point, a road, or an area via the information providing device 50 or the like, and generate the passage information based on the acquired posted road information of the SNS. The posted road information is, for example, congestion information or road closure information. For example, the passage information generation unit 110 may determine at least one of the passable area and the impassable area using the posted road information of the SNS. Further, the passage information generation unit 110 may determine the possibility of passage using the posted road information of the SNS.

Then, the passage information generation unit 110 outputs the generated passage information to the route search unit 130. The passage information generation unit 110 may output the sensor information used for generating the passage information to the route search unit 130. The passage information generation unit 110 may output at least one of the sensor information and the passage information to the route output unit 140. The passage information generation unit 110 may output the information acquired from the information providing device 50 to at least one of the route search unit 130 and the route output unit 140.

The disaster area identification unit 120 acquires, from the SAR 30, an SAR image in a route search target area. The disaster area identification unit 120 may request an SAR image of an area to be acquired from the SAR 30. Alternatively, the disaster area identification unit 120 may acquire an SAR image of a previously designated area from the SAR 30. Then, the disaster area identification unit 120 analyzes a change in the ground surface using the acquired SAR image. Alternatively, the disaster area identification unit 120 may acquire, from the SAR 30, a change in the ground surface related to the area to be acquired. Also in this case, the disaster area identification unit 120 may request a change in the ground surface in the area to be acquired from the SAR 30. As described above, although the subject of the analysis is different, the disaster area identification unit 120 acquires a change in the ground surface, which is a result of the analysis using the measurement result created by the ground surface measurement device. The ground surface measurement device is, for example, the SAR 30. The measurement result is, for example, an SAR image.

Then, the disaster area identification unit 120 identifies a disaster area using a change in the ground surface. For example, in the case of a flood, the ground surface rises due to flooding. Alternatively, in the case of a cliff collapse or a depressed road, the ground surface is low. Therefore, the disaster area identification unit 120 may identify an area where a change in the ground surface exceeds a predetermined threshold value as the disaster area. The disaster area identification unit 120 may change a threshold value used for identification in accordance with a disaster to be identified. For example, the disaster area identification unit 120 may use a value different from a threshold value in the case of determining the depressed road as a threshold value in the case of determining the flood or flooding.

The disaster area identification unit 120 may identify not one disaster area but a plurality of disaster areas. In this case, the disaster area identification unit 120 may identify a plurality of disaster areas for each type of disaster. That is, the disaster area identification unit 120 may identify a disaster area related to each of a plurality of disasters. The plurality of disasters is, for example, flooding and landslides in heavy rain. In this case, the disaster area identification unit 120 may identify a plurality of disaster areas for at least some disasters. Alternatively, the disaster area identification unit 120 may identify a disaster area in which one type of disaster occurs and a disaster area in which a plurality of types of disasters occurs.

A ground surface measurement device such as a multispectra measurement device may be able to provide a measurement result capable of analyzing the type of the ground surface. In this case, the disaster area identification unit 120 may analyze the type of the ground surface using the information acquired from the SAR 30. Alternatively, the disaster area identification unit 120 may acquire the type of the ground surface from the SAR 30. Then, the disaster area identification unit 120 may identify the disaster area using the change in the ground surface and other information, and the type of the ground surface. The other information is, for example, map information. For example, in a case of identifying a disaster area of a flood, the disaster area identification unit 120 may identify, as the disaster area, a range in which a change in the ground surface is larger than a threshold value and a type of the ground surface is a water surface. Alternatively, the disaster area identification unit 120 may identify, as the area of the flood, a range of an area that is the land in normal times in the map information, the range in which the type of the ground surface is a water surface. The land area is, for example, an area that is not a river, a swamp, a pond, or the like.

Further, the disaster area identification unit 120 may include information related to disaster in the disaster area. For example, the disaster area identification unit 120 may include at least one of a type of disaster, a probability of occurrence of disaster, and a risk level of disaster in the disaster area. Hereinafter, the probability of occurrence of a disaster is referred to as a “disaster possibility”. For example, the disaster area identification unit 120 may determine at least one of a disaster type, a disaster possibility, and a risk level using a change in the ground surface (and possibly the type of the ground surface). For example, in the case of a flood, the ground surface rises for almost the entire range of the disaster. On the other hand, in the case of a cliff collapse and a slope collapse, the ground surface includes a lowed place and an elevated place. As described above, the change in the ground surface differs for each disaster. Therefore, the disaster area identification unit 120 may determine the type of disaster using a change in the ground surface. The disaster area identification unit 120 may determine the type of disaster using the type of the ground surface.

Alternatively, a place where the change in the ground surface is large is more likely to have a disaster than a place where the change in the ground surface is small. Therefore, the disaster area identification unit 120 may determine the disaster possibility using a change in the ground surface. For example, the disaster area identification unit 120 may set the disaster possibility of a place where the change in the ground surface is large to be higher than the disaster possibility of a place where the change in the ground surface is small. Alternatively, it can be estimated that a place where the change in the ground surface is large has a higher risk level than a place where the change in the ground surface is small. Therefore, the disaster area identification unit 120 may determine the risk level using a change in the ground surface. For example, the disaster area identification unit 120 may set the risk level of a place where the change in the ground surface is large to be higher than the risk level of a place where the change in the ground surface is small. The disaster area identification unit 120 may include at least one of a type of disaster, a disaster possibility, and a risk level in the disaster area.

Then, the disaster area identification unit 120 outputs the identified disaster area to the route search unit 130. The disaster area output by the disaster area identification unit 120 may include at least one of a disaster type, a disaster possibility, and a risk level. The disaster area identification unit 120 may output the change in the ground surface used to identify the disaster area to the route search unit 130. The disaster area identification unit 120 may output at least one of the disaster area and the change in the ground surface to the route output unit 140.

The route search unit 130 searches for a route to a predetermined point (destination) using the disaster area and the passage information. For example, the route search unit 130 may search for a route to a predetermined point (destination) by avoiding a road where traveling is dangerous or a road where traveling is impassable using a disaster area and passage information. In this case, the route search unit 130 may receive a request for a point to be destined from a user or the like, and search for a route to the requested point. The point to be destined is, for example, an evacuation place. The destination may be an area having a certain size instead of a specific point. That is, the route search unit 130 may search for a route to an area having a certain size instead of a point. Further, the route search unit 130 may receive designation of a departure place from a user or the like in addition to a destination. That is, the route search unit 130 may search for a route from the designated departure place to the destination. In this case, the route search unit 130 may search for a route in which at least one of the departure place and the destination of the route to be searched for is an area. The route in which at least one of the departure place and the destination is an area is a route from a point to an area, a route from an area to a point, or a route from an area to an area. For example, the route search unit 130 may search for a route from the current position of the user to an area outside the disaster area. However, in the following description, for convenience of description, it is assumed that a route to a predetermined point is searched for including the case of an area.

A route search method by the route search unit 130 is not particularly limited. The route search unit 130 may search for a route using any method. For example, the route search unit 130 may use a Dijkstra method, a Bellman-Ford method, or a Floyd-Warshall method. Alternatively, the route search unit 130 may acquire a candidate route and search for a route from the acquired route candidate using the disaster area and the passage information. Hereinafter, a candidate route is referred to as a “route candidate”. In this case, a method of acquiring a route candidate by the route search unit 130 is not particularly limited. The route search unit 130 may use any method as a method of acquiring a route candidate. For example, the route search unit 130 may acquire a route candidate from a user or a predetermined device. For example, the route search unit 130 may acquire a plurality of route candidates from a user or the like and search for a route from the acquired route candidates. Alternatively, the route search unit 130 may acquire a route candidate from a departure place to a destination requested by a user or the like from a device (not illustrated).

Alternatively, the route search unit 130 may extract a route candidate using predetermined information. For example, the route search unit 130 may acquire a departure place and a destination from a predetermined device, acquire map information from the information providing device 50, and extract a route candidate connecting the departure place to the destination from among roads included in the map information. The predetermined device is, for example, a terminal device of the user. A method of extracting a route candidate for connecting from the departure place to the destination by the route search unit 130 is not particularly limited. For example, the route search unit 130 may use a method used for general route search. The method used for general route search is, for example, the above methods.

Then, the route search unit 130 searches for a route using the passage information and the disaster area. For example, a route that is included in the passable area and that is not included in the disaster area is one of routes that allow safe passage. Hereinafter, a route that allows safe passage is referred to as a “recommended route”. Therefore, for example, the route search unit 130 may search for a route that is included in the passable area and that is not included in the disaster area as the recommended route. However, the recommended route is not limited to the above, and may be another route. For example, the recommended route may be a route that is included in the passable area, is away from the disaster area by a predetermined distance or more, and passes through a designated point. The predetermined distance is, for example, 100 meters. The designated point is, for example, a rest place. Alternatively, the route search unit 130 may search for a route that avoids the impassable area and the disaster area. That is, the route search unit 130 may delete a route included in at least one of the impassable area and the disaster area from the route candidates, and use the remaining route candidate as the route.

Alternatively, in a case where the disaster area identification unit 120 acquires the type of the ground surface, the route search unit 130 may search for a route using the type of the ground surface in addition to the passage information and the disaster area. For example, there is a high possibility that it is difficult to pass through an area where the type of the ground surface is a water surface, snow cover, garbage, or mud. Therefore, the route search unit 130 may search for a route not included in the area of the water surface, snow cover, garbage, or mud from among routes searched for using the passage information and the disaster area.

The route search unit 130 may further search for a route satisfying a predetermined condition, such as a condition requested by a user who uses the route, from the routes searched for using the passage information and the disaster area. For example, the route search unit 130 may search for a route with the shortest distance or a route with the shortest travel time from among routes searched for using the passage information and the disaster area. The route search unit 130 may search a plurality of routes instead of one route. For example, the route search unit 130 may search for a predetermined number of routes in ascending order of the distance, or a route having a distance shorter than a predetermined length. Alternatively, the route search unit 130 may search for a predetermined number of routes in ascending order of the travel time or a route having a travel time shorter than a predetermined time.

The predetermined condition is not limited to the above distance or time condition. For example, the route search unit 130 may search for a route through at least one of an evacuation place, a rest place, and a store, a route with a rest place at an interval shorter than a predetermined distance, and a route with a difference in height within a predetermined range. At this time, the route search unit 130 may acquire necessary information from the information providing device 50. For example, the route search unit 130 may acquire information about the position of an evacuation place, a rest place, or a store from the information providing device 50, and search for a route via the evacuation place, the rest place, or the store. Alternatively, the route search unit 130 may acquire the topographical map from the information providing device 50 and determine the difference in height of the route using the acquired topographical map. Then, the route search unit 130 may search for a route that satisfies the condition of the difference in height requested by the user or the like. The route satisfying the condition of the difference in height requested by the user or the like is, for example, a route in which the difference in height is smaller than the requested difference in height.

The route search unit 130 may calculate information related to a route. The information related to the route calculated by the route search unit 130 is not particularly limited. The route search unit 130 may calculate any information as information related to the route. For example, the information related to the route is the position of each point on the route, the length of the route or the length of each section included in the route, the difference in height of the route, and the type of road included in the route. The points on the route are, for example, a departure place, a destination, and a transit point. The type of the road is not limited, but is, for example, the presence or absence of pavement, the type of pavement, and the type of road. The type of road is, for example, a national road, a prefectural road, a municipal road, or a main road or a community road.

The route search unit 130 may determine at least one of the possibility of passage, the disaster possibility, and the risk level of the searched route based on at least one of the possibility of passage including the passage information and the disaster possibility and the risk level included in the disaster area. The method used by the route search unit 130 to determine the possibility of passage, the disaster possibility, and the risk level of the route is not particularly limited. The route search unit 130 may use any method as a method used for determination.

For example, the route search unit 130 may set, as the possibility of passage of the route, the lowest possibility of passage among the possibility of passage of the roads included in the route. Alternatively, the route search unit 130 may set, as the disaster possibility of the route, the highest disaster possibility among the disaster possibilities of the roads included in the route. Alternatively, the route search unit 130 may set, as the risk level of the route, the highest risk level among the risk levels of the roads included in the route. However, the route search unit 130 may determine a possibility of passage, a disaster possibility, or a risk level different from those described above. For example, the route search unit 130 may determine a range of a possibility of passage of a road included in the route as the possibility of passage. The range of the possibility of passage of the road is, for example, a range between a maximum value and a minimum value of the possibility of passage of the road including the route. In this manner, the route search unit 130 may determine a range instead of a specific value as at least one of the possibility of passage, the disaster possibility, and the risk level of the route.

The route search unit 130 may further search for a preferable route from a plurality of routes searched for based on the passage information and the disaster area using at least one of the possibility of passage, the disaster possibility, and the risk level of the route. For example, the route search unit 130 may search for a route having a possibility of passage higher than a predetermined value or a predetermined number of routes in descending order of the possibility of passage of the route from among routes searched for based on the passage information and the disaster area. Alternatively, the route search unit 130 may search for a route having a disaster possibility lower than a predetermined value or a predetermined number of routes in ascending order of the disaster possibility of the route from among the routes searched for based on the passage information and the disaster area. Alternatively, the route search unit 130 may search for a route having a risk level lower than a predetermined value or a predetermined number of routes in ascending order of the risk level of the route from among the routes searched for based on the passage information and the disaster area.

The route search unit 130 may search for a route satisfying the possibility of passage requested by the user or the like based on the determined possibility of passage of the route. The route satisfying the possibility of passage required by the user or the like is, for example, a route having a possibility of passage higher than the required possibility of passage. Alternatively, the route search unit 130 may search for a route satisfying the disaster possibility requested by the user or the like based on the determined disaster possibility of the route. The route that satisfies the disaster possibility required by the user or the like is, for example, a route having a disaster possibility lower than the required disaster possibility. Alternatively, the route search unit 130 may search for a route satisfying the risk level requested by the user or the like based on the determined risk level of the route. The route satisfying the risk level requested by the user or the like is, for example, a route having a risk level lower than the requested risk level. The route search unit 130 may search for a route using any two or all of the possibility of passage, the disaster possibility, and the risk level.

The route search unit 130 may search for a route using the posted road information posted on the SNS. For example, the route search unit 130 may search for a plurality of routes based on passage information and a disaster area, acquire posted road information of the SNS related to each of the plurality of routes, and search for a passable route based on the acquired information. The posted road information is, for example, congestion information or road closure information. Alternatively, the route search unit 130 may search for a route with less congestion using route congestion information in the posted road information of the SNS. Alternatively, the route search unit 130 may search for a route that is not closed using road closure information of the route in the posted road information of the SNS.

In a case of searching for a plurality of routes as a result of the search, the route search unit 130 may set a priority to each of the obtained routes. The information used by the route search unit 130 to set the priority is not particularly limited. The route search unit 130 may use any information as the information used for setting the priority. For example, the route search unit 130 may set the priority based on at least one of the disaster area, the passage information, the possibility of passage of the route, the disaster possibility of the route, the risk level of the route, the type of the ground surface, the posted road information of the SNS, and the calculated information related to the route. For example, the route search unit 130 may increase the priority of a route with high possibility of passage. Alternatively, the route search unit 130 may increase the priority of a route with a low disaster possibility or the priority of a route with a low risk level. Alternatively, the route search unit 130 may increase the priority of a route with a calculated route length that is short, or may increase the priority of a route with a calculated small difference in height that is small. Alternatively, the route search unit 130 may set a priority to a route using a plurality of pieces of information. The plurality of pieces of information is, for example, a weighted average of the possibility of passage and the risk level, or a weighted average of the length and the difference in height.

The route searched for by the route search unit 130 is not particularly limited. The route search unit 130 may search for any route. For example, the route search unit 130 may search for an evacuation route at the time of occurrence of a disaster, may search for a disaster investigation route for investigating a disaster situation, or may search for a supply delivery route for delivering relief supplies and the like at the time of a disaster.

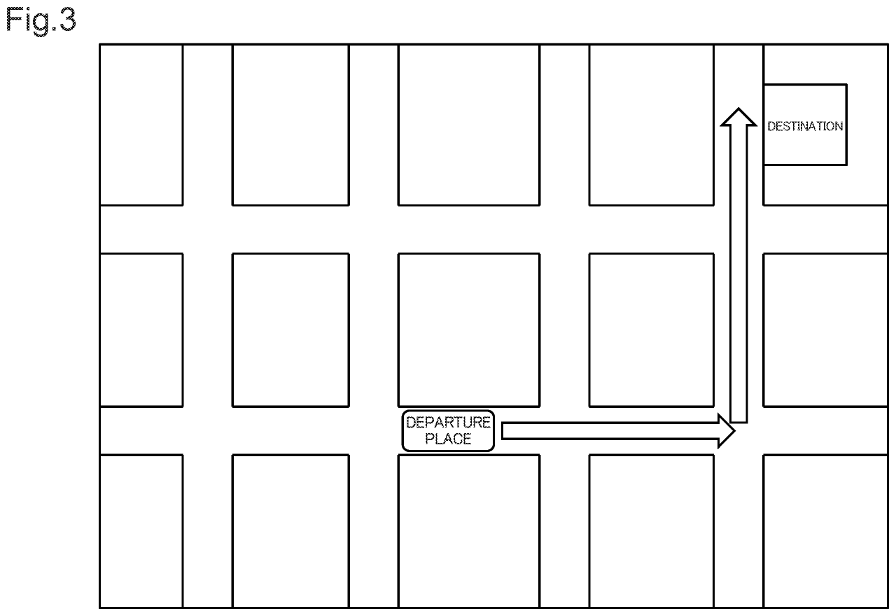

An example of an operation of searching for a route in the route search device 10 will be described with reference to the drawings. FIG. 3 is a diagram illustrating a departure place and a destination used for description. FIG. 3 includes four roads in the up-down direction and two roads in the left-right direction. The road in the up-down direction is divided into three sections with the road in the left-right direction as a boundary. Hereinafter, the three sections are referred to as “upper, central, and lower sections”. The road in the left-right direction is divided into five sections with the road in the up-down direction as a boundary. Hereinafter, the five sections are referred to as “first, second, third, fourth, and fifth sections from right”. FIG. 3 illustrates a route using arrows. The route indicated using two arrows in FIG. 3 is the shortest route as a route from the departure place to the destination, and is a route with the smallest number of direction changes. Therefore, as a normal route in which no disaster has occurred, the route in FIG. 3 is one of desirable routes.

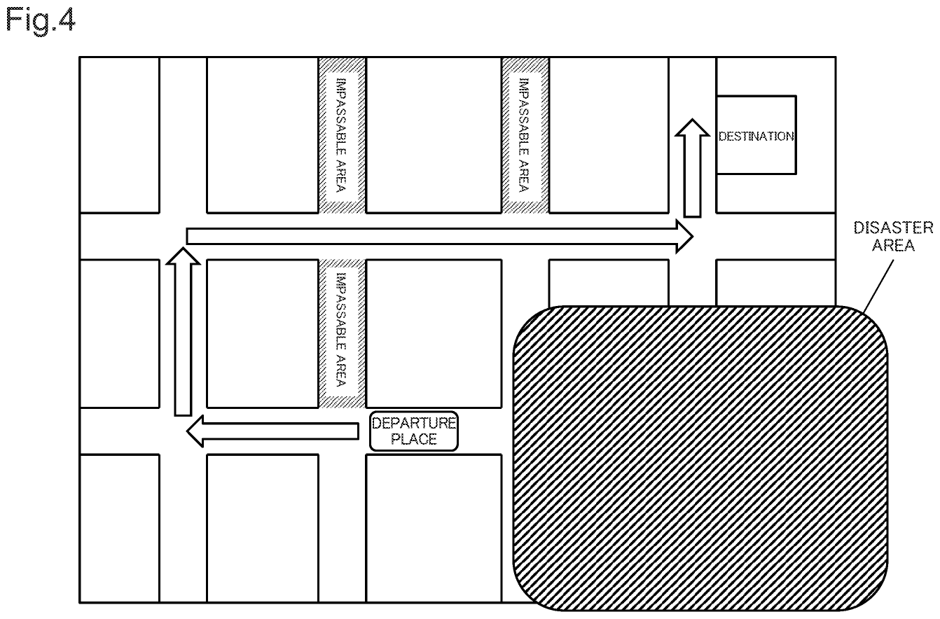

FIG. 4 is a diagram illustrating an example of a route at the time of disaster. In the case of FIG. 4, the passage information generation unit 110 generates passage information including an impassable area using the sensor information. In the case of FIG. 4, the passage information generation unit 110 determines the two upper sections and one central section as an impassable area using the sensor information. The disaster area identification unit 120 identifies a disaster area using a change in the ground surface. The lower right area of FIG. 4 is the identified disaster area. Then, the route search unit 130 searches for a route indicated by four arrows in FIG. 4 as a route avoiding the impassable area included in the passage information and the disaster area. The description returns to the description with reference to FIG. 1.

In a case where there is no recommended route, the route search unit 130 may search for a route passing through at least one of an impassable area and a disaster area. In this case, for example, the route search unit 130 determines at least one of the possibility of passage, the disaster possibility, and the risk level of the route candidate based on the passage information and the disaster area. Then, the route search unit 130 may search for a route from the route candidates based on at least one of the determined possibility of passage, disaster possibility, and risk level.

As an example of this case, the route search unit 130 may search for, as the route, a route candidate having the highest possibility of passage, a predetermined number of route candidates in descending order of the possibility of passage, or a route candidate having a possibility of passage higher than a predetermined value. Alternatively, the route search unit 130 may search for, as the route, a route candidate having the lowest disaster possibility, a predetermined number of route candidates in ascending order of the disaster possibility, or a route candidate having a disaster possibility lower than a predetermined value. Alternatively, the route search unit 130 may search for, as the route, a route candidate having the lowest risk level, a predetermined number of route candidates in descending order of the risk level, or a route candidate having a risk level lower than a predetermined value. Alternatively, the route search unit 130 may search for a route from route candidates based on any two or all of the possibility of passage, the disaster possibility, and the risk level. However, in a case where there is no recommended route, the route search unit 130 may output information indicating that there is no recommended route without searching for a route. In the following description, it is assumed that the route output by the route search unit 130 includes information indicating that there is no route.

Then, the route search unit 130 outputs the searched route to the route output unit 140. The route search unit 130 may output information related to a route. The information related to the route is, for example, the length of the route and the difference in height. The route search unit 130 may output at least one of the passage information and the disaster area used for searching for a route together with the searched route. Alternatively, the route search unit 130 may output at least one of the possibility of passage, the disaster possibility, and the risk level of the route together with the searched route. The route search unit 130 may output information acquired from the information providing device 50 for searching for a route together with the searched route. For example, the information acquired from the information providing device 50 may include information about facilities in the middle of the route, map information, or disaster information. The facility in the middle of the route is, for example, an evacuation place, a rest place, or a store. In a case where a plurality of routes is searched for, the route search unit 130 may output at least one of the priority, the information related to the route, the passage information, the disaster area, the possibility of passage, the risk level, and the information acquired from the information providing device 50, related to each of the plurality of routes. The route search unit 130 may output the sensor information used to generate the passage information and the change in the ground surface used to identify the disaster area in association with the route. For example, the route search unit 130 may output an image including the sensor information in association with the route.

At least one of the passage information generation unit 110, the disaster area identification unit 120, and the route search unit 130 may use predetermined image recognition. In the present example embodiment, the image recognition is not particularly limited. For example, the image recognition includes recognition using a determination model, recognition using another method, and recognition using a combination of them. For example, a user or the like executes machine training using information collected in advance as teacher data, and generates a determination model for extracting a candidate area as a result of the machine training. The information collected in advance is, for example, an image of a road or an SAR image. Then, the user or the like stores the generated determination model in the route search device 10.

For example, in a case where the determination model generated using the sensor information is stored, the passage information generation unit 110 applies the acquired sensor information to the stored determination model to generate the passage information. Alternatively, in a case where a determination model generated using the SAR image is stored, the disaster area identification unit 120 applies the acquired SAR image to the stored determination model to identify the disaster area. Alternatively, in a case where the determination model generated using the passage information and the disaster area is stored, the route search unit 130 applies the acquired passage information and disaster area to the stored determination model to search for a route.

Further, in a case where image recognition is used, at least one of the passage information generation unit 110, the disaster area identification unit 120, and the route search unit 130 may calculate the certainty of the result of the image recognition. Furthermore, at least one of the passage information generation unit 110, the disaster area identification unit 120, and the route search unit 130 may determine a rank of the calculated certainty. The rank is, for example, a high/medium/low certainty. At least one of the passage information generation unit 110, the disaster area identification unit 120, and the route search unit 130 may output at least one of the certainty and the rank to the route output unit 140.

The route output unit 140 outputs the route acquired from the route search unit 130 to a predetermined device. The predetermined device is, for example, the display device 40. The route output unit 140 may output information other than the route together with the route. For example, the route output unit 140 may output the priority of a route together with the route. The route output unit 140 may output a change in the ground surface in association with the route. The route output unit 140 may output the sensor information in association with the route. For example, the route output unit 140 may output an image including the sensor information in association with the route. The route output unit 140 may output at least one of the possibility of passage, the disaster possibility, and the risk level of the route together with the route. The route output unit 140 may output information related to the route. The information related to the route is, for example, the length of the route and the difference in height. The route output unit 140 may output the information acquired from the information providing device 50 in association with the route. The information acquired from the information providing device 50 is, for example, disaster information or map information. Alternatively, the route output unit 140 may output the measurement time of the measurement result by the SAR 30 that has analyzed the change in the ground surface. The measurement by the SAR 30 may have a longer acquisition cycle than that of acquisition of sensor information by the dashcam 20. Therefore, the route search device 10 may output the acquisition time or the measurement time of the measurement result by the SAR 30 as the temporal information related to the determination of the route for the user or the like.

The display device 40 displays the information output by the route output unit 140. The information output by the route output unit 140 is, for example, a route. The timing at which the display device 40 displays information is not particularly limited. The display device 40 may display information at any timing. For example, the display device 40 may start displaying information in response to a request from the user. For example, when acquiring a departure place and a destination from a user and acquiring a request for a route related to the acquired departure place and destination, the display device 40 requests a route related to the departure place and the destination from the route search device 10. Then, the display device 40 displays the route acquired from the route search device 10.

Furthermore, the display device 40 may display information related to a route in response to a request from a user or the like. For example, the display device 40 may display at least one of a length of a route, a difference in height, and a type of a road included in the route in response to a request from a user or the like. The display device 40 may change information related to the displayed route in response to a request from a user or the like. Alternatively, in a case where the route search device 10 uses the determination model, the display device 40 may display the certainty or the rank of the determination using the determination model in response to a request from a user or the like. At this time, the display device 40 may make a request of the route search device 10 for information to be displayed, or may acquire information in advance and change the display in response to the request.

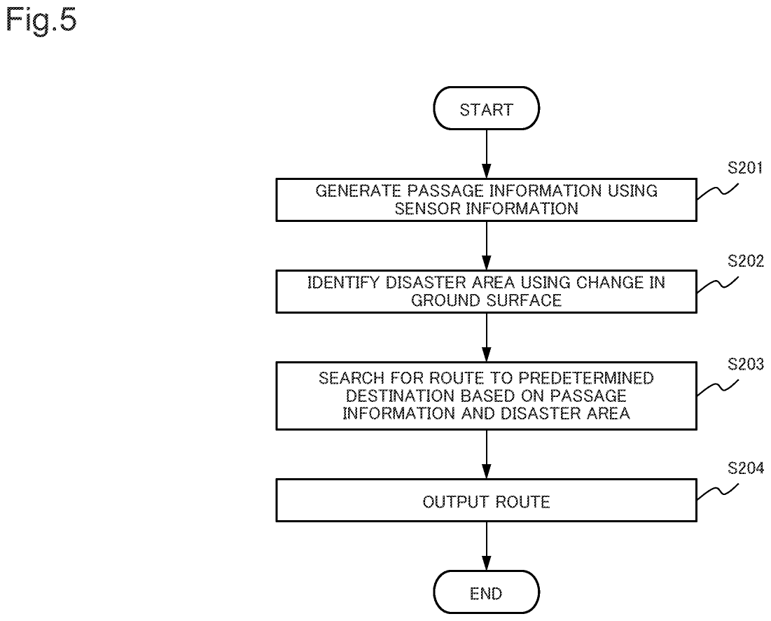

Next, an operation of the route search device 10 according to the first example embodiment will be described with reference to the drawings. FIG. 5 is a flowchart illustrating an example of the operation of the route search device 10 according to the first example embodiment. The route search device 10 generates road passage information using the sensor information acquired from the dashcam 20 (step S201). The route search device 10 identifies a disaster area using a change in the ground surface obtained based on the measurement result by the SAR 30 (step S202). Then, the route search device 10 searches for a route to a predetermined destination using the passage information and the disaster area (step S203). Then, the route search device 10 outputs the searched route to a predetermined device. The predetermined device is, for example, the display device 40.

The route search device 10 configured as described above searches for an appropriate route. The reason is as follows. The route search device 10 includes the passage information generation unit 110, the disaster area identification unit 120, and the route search unit 130. The passage information generation unit 110 generates passage information about a road, using sensor information related to the road, the sensor information being acquired by the sensor information acquisition device. The sensor information acquisition device is, for example, the dashcam 20. The disaster area identification unit 120 identifies a disaster area using a change in the ground surface obtained based on the measurement result created by the ground surface measurement device. The ground surface measurement device is, for example, the SAR 30. The route search unit 130 searches for a route to a predetermined point using the disaster area and the passage information.

The passage information generation unit 110 generates passage information of a road using the sensor information. The passage information is, for example, information including at least one of a passable area and an impassable area. Since the passage information generation unit 110 uses the sensor information, the passage information generation unit 110 can generate the passage information with accuracy of several centimeters to several tens of centimeters. Since the disaster area identification unit 120 uses the change in the ground surface obtained based on the measurement result created by the ground surface measurement device, the disaster area identification unit 120 can identify the disaster area including the area where vehicles cannot pass. Therefore, the route search unit 130 can search for a route using the sensor information that can achieve the above accuracy at least in an area where the sensor information can be acquired. Further, the route search unit 130 can search for a route including an area where vehicles cannot pass using a change in the ground surface. Based on such a configuration, the route search device 10 searches for an appropriate route.

The route search unit 130 may search for a recommended route as a route. The recommended route may be a route included in the passable area included in the passage information and not included in the disaster area. The passable area included in the passage information is an area through which a mobile body such as a vehicle can pass. The disaster area is an area that is highly likely to be dangerous. Therefore, the route search unit 130 can search for a route that allows traveling and avoids a dangerous area. The passage information generation unit 110 may determine traffic congestion of a road using the sensor information and generate passage information based on the determined traffic congestion. In this case, the route search device 10 can search for a route in consideration of the generated traffic jam.

The route search unit 130 may search for a route based on the possibility of passage included in the passage information. The possibility of passage is a possibility of being able to pass through a road. The possibility of being able to pass through the road is, for example, a probability. It is desirable that the route has a higher possibility of passage. Therefore, for example, the route search unit 130 can search for a route having a possibility of passage higher than a predetermined threshold value as an appropriate route. The route search unit 130 may search for a route based on at least one of the disaster possibility and the risk level included in the disaster area. A disaster possibility is a possibility that a disaster has occurred. The possibility that a disaster has occurred is, for example, a probability. The risk level is a risk level of the point or area. The route is desirably a route passing through a place where no disaster has occurred and a safe area. Therefore, for example, the route search unit 130 can search for a more appropriate route such as a route passing through a place with a low disaster possibility or a route passing through a place with a low risk level as an appropriate route using at least one of the disaster possibility and the risk level.

The route search unit 130 may search for a route using the posted road information. For example, the route search unit 130 may search for a route using posted road information posted on the SNS. For example, there is a case where a person who is traveling on a route uploads an image of the route or a comment on a state of the route to the SNS. Therefore, the route search unit 130 may determine the situation of the route using the SNS and search for the route using the determined situation. The passage information generation unit 110 may generate the passage information using the posted road information posted on the SNS. In this case, the passage information generation unit 110 can generate more appropriate passage information. Then, the route search unit 130 can search for a more appropriate route using the passage information generated in this way.

The route search unit 130 may set the priority of a route. In a case where the route search unit 130 searches for a plurality of routes, the user or the like can select a route to be used from the plurality of routes using the priority. That is, the route search device 10 can generate the priority that is information for reference when the user or the like selects a route to be used from a plurality of routes. The sensor information may be sensor information acquired from a sensor information acquisition device mounted on the mobile body. In this case, the route search device 10 can search for a route that can be used by the mobile body. The mobile body is, for example, a vehicle. The sensor information acquisition device is, for example, the dashcam 20.

The route search unit 130 may search for a route satisfying a predetermined condition. The predetermined condition is not limited, but may include, for example, at least one of a condition related to a distance, a time, a rest place, a store, and a difference in height. The route search unit 130 may use a condition including at least one of an evacuation place to pass and a dangerous structure as the predetermined condition. In the case of using a route, the user may want to use a route satisfying a predetermined condition. For example, there is a case where the user wants to use a predetermined facility in addition to simply moving on the route. Therefore, the route search unit 130 may search for a route satisfying a predetermined condition. For example, the route search unit 130 may search for a route shorter than a predetermined distance, a route requiring shorter than a predetermined time, a route via a rest place or a store, and a route having a difference in height within a predetermined range. Alternatively, the route search unit 130 may search for at least one of a route passing through a predetermined evacuation place and a route not passing through a dangerous structure. In this case, the route search device 10 can search for a route with improved user convenience.

The route search device 10 may include the route output unit 140 that outputs a route. In this case, the route search device 10 can output the route to a predetermined device using the route output unit 140. The predetermined device is, for example, the display device 40. The route output unit 140 may output a ground surface change in association with the route. Alternatively, the route output unit 140 may output the sensor information in association with the route. For example, the route output unit 140 may output an image including the sensor information in association with the route. These pieces of information are information for reference when the user or the like uses the route. In this manner, the route search device 10 can output information that serves as a reference in using a route.

The route search system 80 includes the above-described route search device 10, the sensor information acquisition device, the ground surface measurement device, and the display device 40. The sensor information acquisition device is, for example, the dashcam 20). The ground surface measurement device is, for example, the SAR 30. The route search device 10 operates as described above. The sensor information acquisition device outputs the sensor information to the route search device. The ground surface measurement device outputs a ground surface change to the route search device 10. The display device 40 displays the route output by the route search device 10. The route search system 80 can provide a route to a user or the like based on the above configuration.

Next, a hardware configuration of the route search device 10 will be described. Each component of the route search device 10 may be configured by a hardware circuit. Alternatively, in the route search device 10, each component may be configured using a plurality of devices connected via a network. For example, the route search device 10 may be configured using cloud computing. Alternatively, in the route search device 10, the plurality of components may be configured by one piece of hardware.

Alternatively, the route search device 10 may be achieved as a computer device including a central processing unit (CPU), a read only memory (ROM), and a random access memory (RAM). In addition to the above configuration, the route search device 10 may be achieved as a computer device including a network interface circuit (NIC).

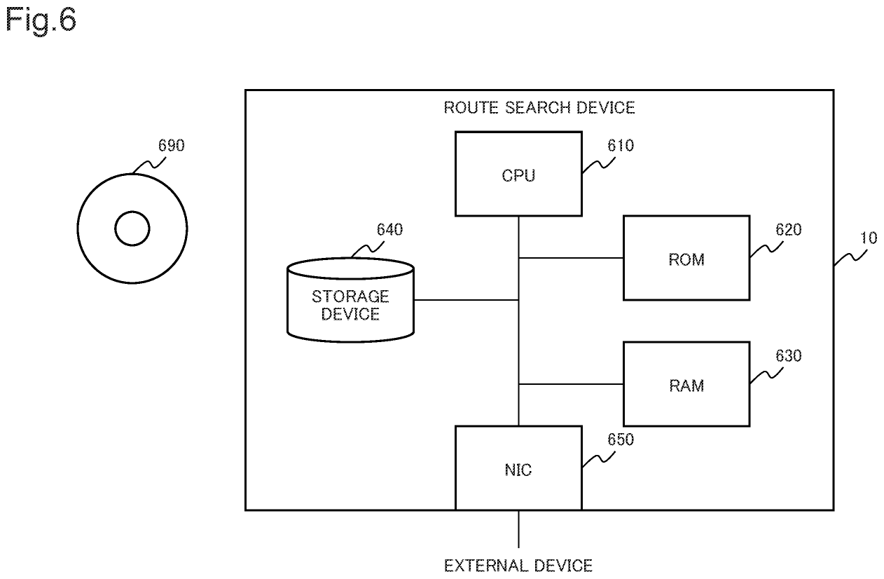

FIG. 6 is a block diagram illustrating an example of a hardware configuration of the route search device 10. The route search device 10 includes a CPU 610, a ROM 620, a RAM 630, a storage device 640, and an NIC 650, and constitutes a computer device. The CPU 610 reads a program from at least any one of the ROM 620 and the storage device 640. Then, the CPU 610 controls the RAM 630, the storage device 640, and the NIC 650 based on the read program. Then, the computer including the CPU 610 controls these configurations to implement the functions of the passage information generation unit 110, the disaster area identification unit 120, the route search unit 130, and the route output unit 140 illustrated in FIG. 1.

When implementing each function, the CPU 610 may use at least one of the RAM 630 and the storage device 640 as a temporary storage medium of a program and data. The CPU 610 may read the program included in a recording medium 690 storing the program in a computer readable manner using a recording medium reading device (not illustrated). Alternatively, the CPU 610 may receive a program from an external device (not illustrated) via the NIC 650, store the program in at least one of the RAM 630 and the storage device 640, and operate based on the stored program.

The ROM 620 stores programs executed by the CPU 610 and fixed data. The ROM 620 is, for example, a programmable ROM (P-ROM) or a flash ROM. The RAM 630 temporarily stores at least one of a program executed by the CPU 610 and data. The RAM 630 is, for example, a dynamic-RAM (D-RAM). The storage device 640 stores data and programs to be stored for a long time by the route search device 10. The storage device 640 may operate as a temporary storage device of the CPU 610. The storage device 640 is, for example, a hard disk device, a magneto-optical disk device, a solid state drive (SSD), or a disk array device.

The ROM 620 and the storage device 640 are non-transitory recording media. On the other hand, the RAM 630 is a transitory recording medium. The CPU 610 is operable based on a program stored in at least one of the ROM 620, the storage device 640, and RAM 630. That is, the CPU 610 can operate using at least one of a non-transitory recording medium and a transitory recording medium.

The NIC 650 relays exchange of data with an external device (not illustrated) via a network. The NIC 650 is, for example, a local area network (LAN) card. Furthermore, the NIC 650 is not limited to use wired communication, but may use wireless communication. The route search device 10 configured as described above can obtain effects similar to those of the route search device 10 in FIG. 1. This is because the CPU 610 of the route search device 10 can implement the function same as that of the route search device 10 in FIG. 1 based on the program.

### Second Example Embodiment

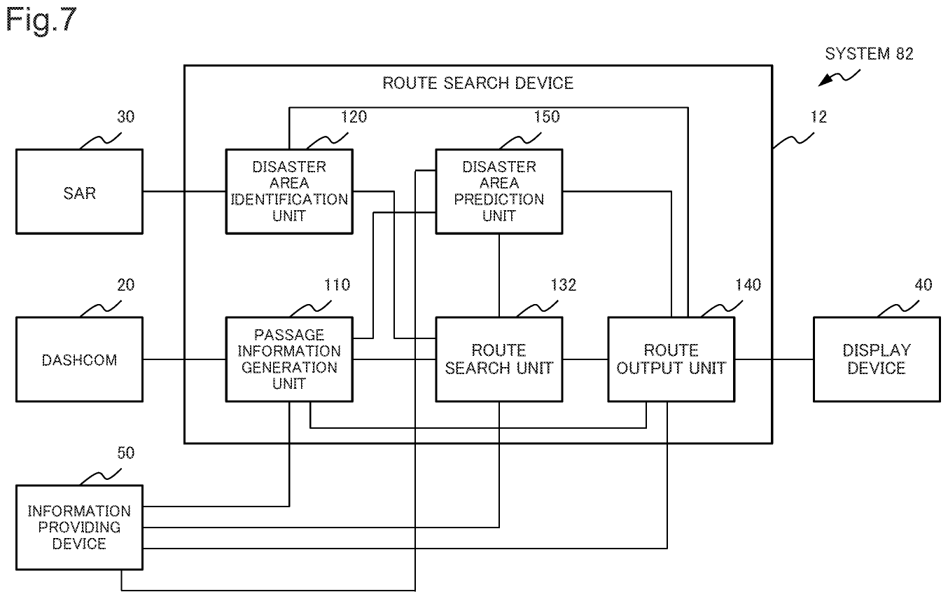

Next, a second example embodiment will be described in detail with reference to the drawings. FIG. 7 is a block diagram illustrating an example of a configuration of a route search system 82 according to the second example embodiment. The route search system 82 includes a configuration similar to that of the route search system 80 except that a route search device 12 is included instead of the route search device 10. Therefore, detailed description of configurations other than the route search device 12 will be omitted.

The route search device 12 includes a route search unit 132 instead of the route search unit 130, and further includes a disaster area prediction unit 150. The passage information generation unit 110 and the disaster area identification unit 120 operate as in the first example embodiment. The route search unit 132 operates as in the route search unit 130 except that the prediction performed by the disaster area prediction unit 150 is used. Further, the route output unit 140 operates as in the route output unit 140 of the first example embodiment except that the operation results by the route search unit 132 and the disaster area prediction unit 150 are output. Therefore, the description similar to that of the first example embodiment will be omitted as appropriate, and the disaster area prediction unit 150 will be mainly described below. The route search device 12 may be configured using the hardware illustrated in FIG. 6.

The disaster area prediction unit 150 predicts a change in the ground surface at a future predetermined time point using the history of a change in the ground surface acquired by the disaster area identification unit 120. The history may be, for example, time series information. Then, the disaster area prediction unit 150 identifies a disaster area at a predetermined time point using the predicted change in the ground surface. The disaster area is, for example, a flood range. As a method of identifying a disaster area using a change in the ground surface predicted by the disaster area prediction unit 150, a method similar to that of the disaster area identification unit 120 may be used. The disaster area prediction unit 150 may use any future time point as the predetermined time point. For example, the disaster area prediction unit 150 may use a time point requested by a user or the like as the predetermined time point. Alternatively, the disaster area prediction unit 150 may use a plurality of predetermined time points.

Further, the disaster area prediction unit 150 may predict the passage information at a predetermined time point using the history of the sensor information. For example, the disaster area prediction unit 150 may predict an impassable area. In the case of prediction at a plurality of predetermined time points, the disaster area prediction unit 150 may predict different targets at least some of the predetermined time points. For example, the disaster area prediction unit 150 may predict a disaster area at a certain predetermined time point and predict passage information at another predetermined time point. Alternatively, the disaster area prediction unit 150 may predict a disaster area at a certain predetermined time point, and predict a disaster area and passage information at another predetermined time point.

The configuration for storing the history of a change in the ground surface and the history of the sensor information is not particularly limited. For example, the disaster area prediction unit 150 may store at least one of the history of a change in the ground surface and the history of sensor information. Alternatively, a storage unit (not illustrated) may store at least one of the history of a change in the ground surface and the history of sensor information. Alternatively, an external device (not illustrated) may store at least one of the history of a change in the ground surface and the history of sensor information.

A method used by the disaster area prediction unit 150 to predict a disaster area and passage information is not particularly limited. For example, the disaster area prediction unit 150 may predict at least one of the disaster area and the passage information by applying a predetermined statistical prediction method to at least one of the history of the change in the ground surface and the history of the sensor information. The statistical prediction method is, for example, an autoregressive model, a moving average method, or an exponential average method. Alternatively, the disaster area prediction unit 150 may use a prediction model generated using machine training using at least one of the past change in the ground surface and sensor information as teacher data. Furthermore, the disaster area prediction unit 150 may predict at least one of the time of occurrence of the secondary disaster and the range of the secondary disaster at a predetermined time point based on at least one of the history of the change in the ground surface and the history of the sensor information.

The disaster area prediction unit 150 may predict at least one of the disaster area and the passage information at the predetermined time point using the history of the type of the ground surface in addition to at least one of the history of the change in the ground surface and the history of the sensor information. The history of the type of the ground surface is, for example, a history of a water surface. The disaster area is, for example, a flood range. Alternatively, the disaster area prediction unit 150 may predict at least one of the disaster area and the passage information at the predetermined time point using information acquired from the information providing device 50 or the like in addition to at least one of the history of the change in the ground surface and the history of the sensor information. The information acquired from the information providing device 50 or the like is, for example, disaster information. In the prediction, the disaster area prediction unit 150 may use information related to the land such as altitude, topography, and geology of each place.

The disaster area prediction unit 150 may change the method used for prediction of at least one of the disaster area and the passage information according to the type of disaster. The type of disaster is, for example, a flood or an earthquake. For example, in the case of a flood, the disaster area and the impassable area are the range flooded by the flood. Therefore, the disaster area prediction unit 150 predicts at least one of the disaster area and the passage information based on the history of the change in the ground surface (and the history of the type of the ground surface when available). In this case, the disaster area is, for example, a flood range. On the other hand, regarding the damage on the road surface in the case of the earthquake, not only the change in the ground surface but also the progress of recovery is different in relation to the damage state of the road surface in the earthquake. The damage state of the road surface is, for example, a state of a crack, a pot hole, and a depression. Therefore, in the case of an earthquake, the disaster area prediction unit 150 may predict at least one of the disaster area and the passage information based on the damage state of the road surface predicted based on the history of the sensor information in addition to the prediction of the change in the ground surface determined based on the history of the change in the ground surface.

The route search unit 132 searches for a route at a predetermined time point using at least one of the predicted disaster area and the predicted passage information. The predetermined time point is a time point when a disaster area or the like is predicted. The route search unit 132 may search for a route using at least one of the predicted occurrence time of the secondary disaster and the range of the secondary disaster. In a case where the disaster area prediction unit 150 predicts disaster areas or the like at a plurality of predetermined time points, the route search unit 132 may search for routes at a plurality of predetermined time points.

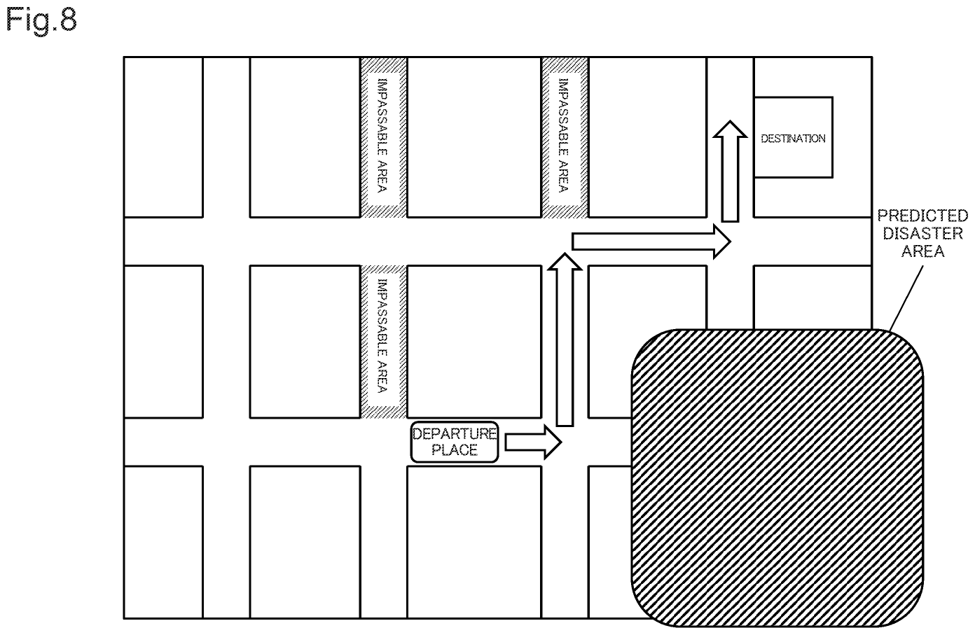

FIG. 8 is a diagram for explaining a route searched by the route search unit 132 based on the prediction of the disaster area. FIG. 8 illustrates a disaster area predicted by the disaster area prediction unit 150 after a predetermined time from the time in FIG. 4. After the predetermined time is, for example, after 12 hours. The disaster area is, for example, a range in which a change in the ground surface is large. As illustrated in FIG. 8, the disaster area prediction unit 150 predicts that the disaster area after the predetermined time is narrower than the disaster area in FIG. 4. The route search unit 132 searches for a route using the predicted disaster area. As a result, the route search unit 132 searches for a route indicated using four arrows in FIG. 8. The route indicated by the four arrows in FIG. 8 are shorter than the route indicated by the four arrows in FIG. 4 as the disaster area is reduced.

The disaster area prediction unit 150 may predict the recovery time of the passage of the road using at least one of the history of the change in the ground surface and the history of the sensor information. The method by which the disaster area prediction unit 150 predicts the recovery time is not particularly limited. For example, the disaster area prediction unit 150 predicts the possibility of the recovery state of the road at a predetermined time point based on the prediction of the change in the ground surface predicted using the history of the change in the ground surface and the state of the road predicted using the history of the sensor information. For example, the disaster area prediction unit 150 predicts the possibility of passage as the possibility of the recovery state. For example, the disaster area prediction unit 150 may predict the possibility of recovery using a prediction model generated as a result of machine training using a history of a change in the ground surface in the past and a history of sensor information in the past as teacher data. Then, the disaster area prediction unit 150 may set the time when the possibility of the recovery state of the road exceeds a predetermined value as the recovery time. The time when the possibility of the recovery state of the road exceeds a predetermined value is, for example, a time when the possibility of passage exceeds 90%. Then, the route search unit 132 may search for a route including the restored road using the recovery time.

For example, in a case where there is no recommended route, the route search device 12 may predict the time when at least one route is the recommended route using the recovery time. A method of predicting the time when the route is the recommended route by the route search device 12 is not particularly limited. The route search device 12 may use any method as a method of predicting the time when the route is the recommended route. For example, the recovery time of the route is the last recovery time among the recovery times of the roads constituting the route. Therefore, first, the disaster area prediction unit 150 predicts a recovery time of each road. Then, the route search unit 132 predicts a recovery time of each route candidate to a predetermined destination using the predicted recovery time of each road. Then, the route search unit 132 may search for the recovery time of the route candidate that has the earliest recovery time among the predicted recovery times of the route candidates as the time when at least one route is the recommended route. Further, the route search unit 132 may search for a route candidate having the earliest recovery time as a route having the recovery time (recommended route).

The disaster area prediction unit 150 may acquire information related to a road recovery work such as a recovery plan of a local government from a predetermined device, and predict a road recovery time using the acquired information related to the recovery work. The recovery plan is not particularly limited. For example, in a case where the damage is a fallen tree, the recovery plan may be a fallen tree removal plan. Alternatively, in a case where the damage is a crack in the road, the recovery plan may be a road repair plan. Alternatively, in a case where the damage is the depression of the road, the recovery plan may be a road repair plan. The route search unit 132 may search for a route based on the predicted recovery time of the road.

The prediction of the disaster area prediction unit 150 may include an error. Therefore, there is a case where it is not possible to actually pass through the route searched by the route search unit 132 based on the prediction. Therefore, the route search device 12 may output sensor information related to a route searched for based on prediction to a predetermined device via the route output unit 140. The predetermined device is, for example, the display device 40. In this case, the user or the like may determine the state of the route searched for based on the prediction by referring to the output sensor information, and determine whether to use the route (the route searched for based on the prediction).

Furthermore, it is assumed that there is unacquired sensor information related to a route searched for based on prediction among the sensor information already acquired by the dashcam 20. For example, after the route search device 12 acquires the sensor information used for prediction, the vehicle on which the dashcam 20 is mounted may be traveling on a route searched for based on the prediction or the vicinity of the route. Alternatively, the dashcam 20 which is a fixed camera may acquire sensor information about a route searched for based on prediction. In such a case, the route search device 12 may acquire sensor information about a route searched for based on prediction to output the sensor information to the display device 40 or the like.

For example, the route search device 12 may inquire of the dashcam 20 whether there is unacquired sensor information related to the predicted route using the passage information generation unit 110, and acquire the unacquired sensor information in a case where there is the unacquired sensor information. Then, the route search device 12 may output newly acquired sensor information to a predetermined device via the route output unit 140. The predetermined device is, for example, the display device 40. As in the above, the user or the like may check the output sensor information and determine the possibility of passage or the like of the predicted route. The sensor information is, for example, an image. The route search device 12 may execute prediction and route search again using newly acquired sensor information. In this manner, the route search device 12 may repeat the prediction and the route search.

The route search device 12 may newly acquire sensor information using the passage information generation unit 110 at the predicted predetermined time point. Then, the route search device 12 may output newly acquired sensor information to a predetermined device. The predetermined device is, for example, the display device 40. The user or the like may determine whether the predicted route is passable as predicted with reference to the output sensor information. In this case, the disaster area prediction unit 150 may predict the time when the sensor information can be acquired on the route. Then, the route search device 12 may output the time when the sensor information can be acquired to a predetermined device via the route output unit 140. The user or the like may formulate a plan for acquiring the sensor information with reference to the displayed time.

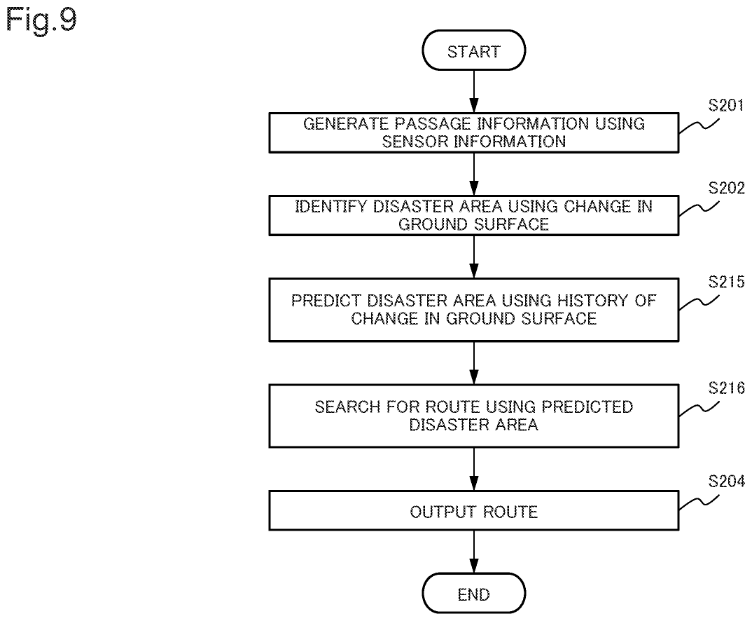

Next, an operation of the route search device 12 according to the second example embodiment will be described with reference to the drawings. FIG. 9 is a flowchart illustrating an example of the operation of the route search device 12 according to the second example embodiment. The passage information generation unit 110 generates passage information using the sensor information acquired by the dashcam 20 (step S201). The disaster area identification unit 120 determines a disaster area using a change in the ground surface obtained based on the measurement result by the SAR 30 (step S202).

The disaster area prediction unit 150 predicts a disaster area at a predetermined time point using a history of a change in the ground surface (step S215). The disaster area prediction unit 150 may predict the disaster area at a predetermined time point using the history of the sensor information. The disaster area prediction unit 150 may predict the passage information at the predetermined time point using at least one of the history of the change in the ground surface and the history of the sensor information. Then, the route search unit 132 searches for a route at a predetermined time point using the predicted disaster area (step S216). The route search unit 132 may search for a route at a predetermined time point using the predicted passage information. Then, the route output unit 140 outputs the route at the predetermined time point to a predetermined device (step S204). The predetermined device is, for example, the display device 40. The route search unit 132 may search for a route after step S202, as in the operation described with reference to FIG. 5.

The route search device 12 according to the second example embodiment can search for an appropriate route at a predetermined time point in addition to the effects of the first example embodiment. The reason is as follows. Unlike the route search device 10, the route search device 12 includes a route search unit 132 instead of the route search unit 130, and further includes a disaster area prediction unit 150. The disaster area prediction unit 150 predicts a disaster area at a predetermined time point using a history of a change in the ground surface. The route search unit 132 searches for a route at a predetermined time point using the predicted disaster area. In this manner, the route search device 12 can search for a route at a predetermined time point using the above configuration.

The disaster area prediction unit 150 may predict the passage information at a predetermined time point using the history of the sensor information. The route search unit 132 may search for a route at a predetermined time point using predicted passage information. In this case, the route search device 12 can search for a more appropriate route using at least one of the history of the ground surface change and the history of the sensor information.

The disaster area prediction unit 150 may predict a recovery time of a road. Further, the route search unit 132 may search for a route using the recovery time. In this case, the route search device 12 can search for a route in consideration of the predicted recovery time of the road. The route search unit 132 may predict the time when at least one route is to be the recommended route. In this case, in a case where there is no recommended route, the route search device 12 can predict the time when the recommended route can be used along with the recovery of the road. The route output unit 140 may output the time when at least one route is the recommended route, and the recommended route. In this manner, the route search device 12 can provide information related to prediction to the user or the like.

### Third Example Embodiment

The route search device 10 may store the searched route in a storage unit (not illustrated) to output the route in response to a request from a user or the like. Alternatively, the route search device 10 may include a display unit (not illustrated) and display a route on the display unit. In this case, the route search device 10 may not include the route output unit 140. Therefore, as the third example embodiment, the above case will be described.

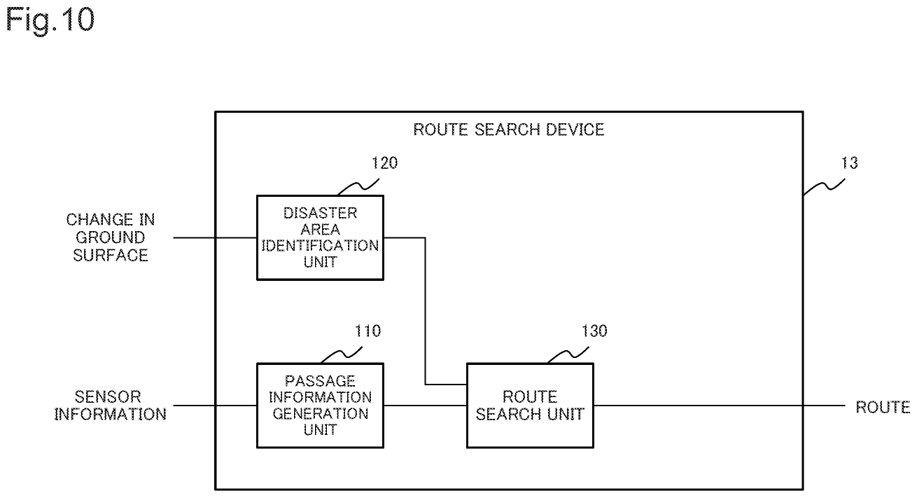

FIG. 10 is a block diagram illustrating an example of a configuration of a route search device 13 according to the third example embodiment. The route search device 13 includes the passage information generation unit 110, the disaster area identification unit 120, and the route search unit 130. The passage information generation unit 110 generates passage information about a road, using sensor information related to the road, the sensor information being acquired by the sensor information acquisition device. The sensor information acquisition device is, for example, the dashcam 20. The disaster area identification unit 120 identifies a disaster area using a change in the ground surface obtained based on the measurement result created by the ground surface measurement device. The ground surface measurement device is, for example, the SAR 30. The route search unit 130 searches for a route to a predetermined point using the passage information and the disaster area. The route search device 13 may be configured using a hardware configuration illustrated in FIG. 6. The route search device 13 configured as described above can search for an appropriate route as in the route search device 10.

### Fourth Example Embodiment

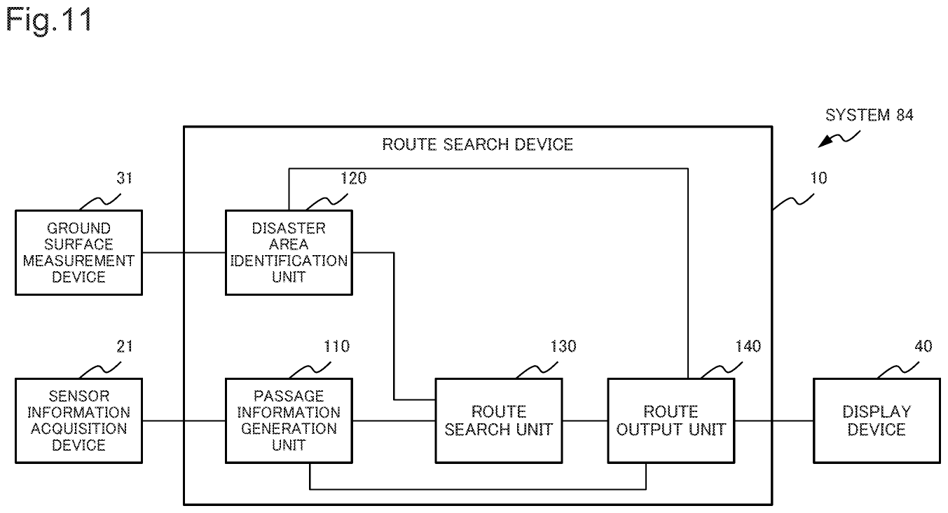

The route search system 80 may not include the information providing device 50. Therefore, an example of such a case will be described as the fourth example embodiment. FIG. 11 is a block diagram illustrating an example of a configuration of a route search system 84 according to the fourth example embodiment. The route search system 84 includes the route search device 10, a sensor information acquisition device 21, a ground surface measurement device 31, and the display device 40. The route search device 10 includes a passage information generation unit 110, a disaster area identification unit 120, a route search unit 130, and a route output unit 140. The route search device 10 operates as in the route search device 10 of the first example embodiment except that information is not acquired from the information providing device 50. The route search device 10 according to the fourth example embodiment may be configured using a hardware configuration illustrated in FIG. 6.

In the route search system 84 configured as described above, the route search device 10 operates as described above. That is, the route search device 10 generates passage information using the sensor information acquired by the sensor information acquisition device 21. The sensor information acquisition device 21 is, for example, the dashcam 20. Then, the route search device 10 acquires a ground surface change obtained based on the measurement result created by the ground surface measurement device 31. Then, the route search device 10 identifies a disaster area using a change in the ground surface. The ground surface measurement device 31 is, for example, the SAR 30. Then, the route search device 10 searches for a route to a predetermined point based on the passage information and the disaster area. Then, the route search device 10 outputs the route. The sensor information acquisition device 21 outputs the sensor information to the route search device 10. The ground surface measurement device 31 outputs a measurement result to the route search device 10. Then, the display device 40 acquires the route from the route search device 10 and displays the route. The route search system 84 configured as described above can obtain the same effect as the route search system 80.

Some or all of the above example embodiments may be described as the following Supplementary Notes, but are not limited to the following.

### (Supplementary Note 1)

A route search device including
a passage information generation means configured to generate passage information about a road, using sensor information related to the road, the sensor information being acquired by a sensor information acquisition device,
a disaster area identification means configured to identify a disaster area using a change in a ground surface obtained based on a measurement result created by the ground surface measurement device, and
a route search means configured to search for a route to a predetermined point using the disaster area and the passage information.

### (Supplementary Note 2)

The route search device according to Supplementary Note 1, wherein
the route search means searches for a recommended route as the route.

### (Supplementary Note 3)

The route search device according to Supplementary Note 2, wherein
the recommended route is a route that is included in a passable area included in the passage information and that is not included in the disaster area.

### (Supplementary Note 4)

The route search device according to any one of Supplementary Notes 1 to 3, wherein
the passage information generation means determines traffic congestion of a road using the sensor information, and generates the passage information based on the determined traffic congestion.

### (Supplementary Note 5)

The route search device according to any one of Supplementary Notes 1 to 4, wherein
the route search means searches for the route based on at least one of a possibility of passage included in the passage information and a disaster possibility and a risk level included in the disaster area.

### (Supplementary Note 6)

The route search device according to any one of Supplementary Notes 1 to 5, further including
a disaster area prediction means configured to predict the disaster area at a predetermined time point using a history of the change in the ground surface, wherein
the route search means searches for the route at the predetermined time point using the predicted disaster area.

### (Supplementary Note 7)

The route search device according to Supplementary Note 6, wherein
the disaster area prediction means predicts the passage information at the predetermined time point using a history of the sensor information, and
the route search means searches for the route at the predetermined time point using the predicted passage information.

### (Supplementary Note 8)

The route search device according to Supplementary Note 6 or 7, wherein
the disaster area prediction means predicts a recovery time of a road, and
the route search means searches for the route using the recovery time of the road.

### (Supplementary Note 9)

The route search device according to any one of Supplementary Notes 6 to 8, wherein
the route search means predicts a time when at least one of the routes is a recommended route.

### (Supplementary Note 10)

The route search device according to any one of Supplementary Notes 1 to 9, wherein
the route search means searches for the route using posted road information.

### (Supplementary Note 11)

The route search device according to Supplementary Note 10, wherein
the route search means searches for the route using the posted road information posted on a social networking service.

### (Supplementary Note 12)

The route search device according to Supplementary Note 11, wherein
the passage information generation means generates the passage information using the posted road information posted on a social networking service.

### (Supplementary Note 13)

The route search device according to any one of Supplementary Notes 1 to 12, wherein
the route search means sets a priority to the route.

### (Supplementary Note 14)

The route search device according to any one of Supplementary Notes 1 to 13, wherein
the sensor information is sensor information acquired from the sensor information acquisition device mounted on a mobile body.

### (Supplementary Note 15)

The route search device according to any one of Supplementary Notes 1 to 14, wherein
the route search means searches for the route satisfying a predetermined condition.

### (Supplementary Note 16)

The route search device according to Supplementary Note 15, wherein
the predetermined condition includes at least one of a condition related to a distance, a time, a rest place, a store, and a difference in height.

### (Supplementary Note 17)

The route search device according to Supplementary Note 16, wherein
the predetermined condition includes at least one of an evacuation place to pass and a dangerous structure.

### (Supplementary Note 18)

The route search device according to any one of Supplementary Notes 1 to 17, further including
a route output means configured to output the route.

### (Supplementary Note 19)

The route search device according to Supplementary Note 18, wherein
the route output means outputs at least one of the change in the ground surface and the sensor information in association with the route.

### (Supplementary Note 20)

The route search device according to any one of Supplementary Notes 2 to 17, further including
a route output means configured to output a time when at least one of the routes is a recommended route, and the recommended route.

### (Supplementary Note 21)

A route search system including
the route search device according to any one of Supplementary Notes 1 to 20, and
the sensor information acquisition device that outputs the sensor information to the route search device.

### (Supplementary Note 22)

A route search method including
generating passage information about a road by using sensor information related to the road, the sensor information being acquired by a sensor information acquisition device,
identifying a disaster area using a change in a ground surface obtained based on a measurement result created by the ground surface measurement device, and
searching for a route to a predetermined point using the disaster area and the passage information.

### (Supplementary Note 23)

A route search method including
a route search device executing the route search method according to Supplementary Note 22, and
the sensor information acquisition device outputting the sensor information to the route search device.

### (Supplementary Note 24)

A recording medium that records a program for causing a computer to execute the steps of
generating passage information about a road by using sensor information related to the road, the sensor information being acquired by a sensor information acquisition device,
identifying a disaster area using a change in a ground surface obtained based on a measurement result created by the ground surface measurement device, and
searching for a route to a predetermined point using the disaster area and the passage information.

Although the present invention is described above with reference to the example embodiments, the present invention is not limited to the above example embodiments. It will be understood by those of ordinary skill in the art that various changes in form and details may be made therein without departing from the spirit and scope of the present invention as defined by the claims.

### REFERENCE SIGNS LIST

10 route search device
12 route search device
13 route search device
20 dashcam
21 sensor information acquisition device
30 SAR
31 ground surface measurement device
40 display device
50 information providing device
80 route search system
82 route search system
84 route search system
110 passage information generation unit
120 disaster area identification unit
130 route search unit
132 route search unit
140 route output unit
150 disaster area prediction unit
610 CPU
620 ROM
630 RAM
640 storage device
650 NIC
810 computer
820 dashcam
830 SAR system
840 terminal device
850 vehicle
880 network

What is claimed is:

1. A route search device comprising:
a memory configured to store instructions; and
one or more processors configured to execute the instructions to:
generate passage information about a road, using sensor information related to the road, the sensor information being acquired by a sensor information acquisition device;
identify a disaster area using a change in a ground surface obtained based on a measurement result created by the ground surface measurement device; and
search for a route to a predetermined point using the disaster area and the passage information.

2. The route search device according to claim 1, wherein
the one or more processors are further configured to:
search for a recommended route as the route.

3. The route search device according to claim 2, wherein
the recommended route is a route that is included in a passable area included in the passage information and that is not included in the disaster area.

4. The route search device according to claim 1, wherein
the one or more processors are further configured to:
determine traffic congestion of a road using the sensor information, and generate the passage information based on the determined traffic congestion.

5. The route search device according to claim 1, wherein
the one or more processors are further configured to:
search for the route based on at least one of a possibility of passage included in the passage information, and a disaster possibility and a risk level included in the disaster area.

6. The route search device according to claim 1, wherein
the one or more processors are further configured to:
predict the disaster area at a predetermined time point using a history of the change in the ground surface; and
search for the route at the predetermined time point using the predicted disaster area.

7. The route search device according to claim 6, wherein
the one or more processors are further configured to:
predict the passage information at the predetermined time point using a history of the sensor information; and
search for the route at the predetermined time point using the predicted passage information.

8. The route search device according to claim 6, wherein
the one or more processors are further configured to:
predict a recovery time of a road; and
search for the route using the recovery time of the road.

9. The route search device according to claim 1, wherein
the one or more processors are further configured to:
predict a time when at least one of the routes is a recommended route.

10. The route search device according to claim 1, wherein
the one or more processors are further configured to:
search for the route using posted road information.

11. The route search device according to claim 10, wherein
the one or more processors are further configured to:
search for the route using the posted road information posted on a social networking service.

12. The route search device according to claim 11, wherein
the one or more processors are further configured to:
generate the passage information using the posted road information posted on a social networking service.

13. The route search device according to claim 1, wherein
the one or more processors are further configured to:
set a priority to the route.

14. The route search device according to claim 1, wherein
the sensor information is the sensor information acquired from the sensor information acquisition device mounted on a mobile body.

15. The route search device according to claim 1, wherein
the one or more processors are further configured to:
search for the route satisfying a predetermined condition.

16. The route search device according to claim 15, wherein
the predetermined condition includes at least one of the conditions related to a distance, a time, a rest place, a store, and a difference in height.

17. The route search device according to claim 16, wherein
the predetermined condition includes at least one of an evacuation place to pass and a dangerous structure.

18. The route search device according to claim 1, wherein
the one or more processors are further configured to:
output the route.

19-21. (canceled)

22. A route search method comprising:
generating passage information about a road by using sensor information related to the road, the sensor information being acquired by a sensor information acquisition device;
identifying a disaster area using a change in a ground surface obtained based on a measurement result created by the ground surface measurement device; and
searching for a route to a predetermined point using the disaster area and the passage information.

23. (canceled)

24. A non-transitory computer-readable recording medium that records a program for causing a computer to execute:
generating passage information about a road by using sensor information related to the road, the sensor information being acquired by a sensor information acquisition device;
identifying a disaster area using a change in a ground surface obtained based on a measurement result created by the ground surface measurement device; and
searching for a route to a predetermined point using the disaster area and the passage information.
